(19) United States
(12) Patent Application Publication
(10) Pub. No.: US 2026/0346233 A1
(43) Pub. Date: Nov. 5, 2026

(54) CATALYST MOLDING FOR HYDROGEN PEROXIDE ACTIVATION

(71) Applicant: BASF SE, Ludwigshafen am Rhein (DE)

(72) Inventors: Andrei-Nicolae PARVULESCU, Ludwigshafen am Rhein (DE); Natalia TRUKHAN, Ludwigshafen am Rhein (DE); Trees Maria DE BAERDEMAEKER, Ludwigshafen am Rhein (DE); Joaquim Henrique TELES, Ludwigshafen am Rhein (DE); Jaroslaw Michael MORMUL, Ludwigshafen am Rhein (DE); Christophe COPERET, Zurich (CH); Lukas LAETSCH, Zurich (CH)

(21) Appl. No.: 19/487,229

(22) PCT Filed: Feb. 5, 2024
(86) PCT No.: PCT/EP2024/052763

§ 371 Date: Nov. 24, 2025

(30) Foreign Application Priority Data
May 31, 2023 (EP) 23176531.4

(51) Int. Cl. B01J 21/06; B01J 6/00; B01J 35/61; B01J 37/00; B01J 37/04; B01J 37/06; C01B 15/01

(52) U.S. Cl. CPC B01J 21/063; B01J 6/001; B01J 35/613; B01J 35/615; B01J 35/617; B01J 37/0009; B01J 37/04; B01J 37/06; C01B 15/01

(57) ABSTRACT

The present invention relates to a catalyst molding for hydrogen peroxide activation, wherein the catalyst molding comprises a catalyst for hydrogen peroxide activation, said catalyst comprising Ti, Si, and O, wherein the catalyst comprised in the catalyst molding displays a water adsorption (W), a concentration (C) of bridging μ²η²-peroxo species per Ti in the H₂O₂-activated catalyst as determined by quantitative 170 NMR spectroscopy, and a specific activation factor (A) according to formula I, wherein in accordance with formula I, the activation factor is the multiplication product of the water adsorption and the concentration of bridging μ²η²-peroxo species per Ti in the H₂O₂-activated catalyst:

A=W×C (I).

The present invention further relates to a method for the preparation of a catalyst molding catalyst molding obtainable or obtained by said method. Yet further, the present invention relates to a process for the activation of hydrogen peroxide, and to the use of the inventive catalyst molding in a reaction involving one or more of C—O bond formation, C—C bond formation and C—C bond conversion.

### TECHNICAL FIELD

The present invention relates to a catalyst molding for hydrogen peroxide activation, wherein the catalyst molding comprises a catalyst, wherein the catalyst comprises Ti, Si, and O, and wherein the catalyst displays a water adsorption (W), a concentration (C) of bridging μ²η²-peroxo species per Ti in the H₂O₂-activated catalyst as determined by quantitative ¹⁷O NMR spectroscopy, and a specific activation factor (A), wherein the activation factor is the multiplication product of the water adsorption and the concentration of bridging μ²η²-peroxo species per Ti in the H₂O₂-activated catalyst. Furthermore, the present invention relates to a method for the preparation of a catalyst molding, as well as to a catalyst molding obtainable or obtained by said process. Yet further, the present invention relates to a process for the activation of hydrogen peroxide, and use of the inventive catalyst molding in a reaction involving one or more of C—O bond formation, C—C bond formation and C—C bond conversion.

### INTRODUCTION

Oxidation reactions such as ammoximation, hydroxylation, and epoxidation reactions are typically carried out in the presence of specific catalysts. In particular, zeolitic materials comprising Si and a further tetravalent element are known to be efficient catalysts, wherein these zeolitic materials are often employed in the form of moldings which, in addition to the catalytically active zeolitic material, comprise a suitable binder.

Such materials are widely used in industry. For example, epoxidation catalysts are employed on a large scale for the epoxidation of olefins with hydrogen peroxide (H₂O₂), leaving only water as a byproduct. In this regard, titanosilicates having an MFI framework structure containing 1-2 wt.-% Ti in which the silicon atoms were substituted for titanium atoms have proven to be efficient catalysts. For instance, U.S. Pat. No. 4,410,501 relates to the preparation of a porous crystalline synthetic material comprising silicon and titanium oxides. WO 2020/074586 A1, on the other hand, relates to a molding comprising a zeolitic material having the framework type MFI.

U.S. Pat. No. 9,302,257 B2 relates to a process for the preparation of a titanium zeolite catalyst, whereas WO 2021/123227 A1 relates to the continuous synthesis of a titanosilicate zeolitic material such as TS-1. WO 2020/174586 A1, on the other hand, relates to a molding comprising a zeolitic material having the MFI-type framework structure.

Titanium silicalite-1 (TS-1), as a specific titanosilicate, was the subject of a study on the efficient epoxidation over its dinuclear sites in C. P. Gordon et al., Nature 2020, 586, 708-713. Generally, it was assumed that the catalytic properties of TS-1 are attributed to the presence of isolated Ti(IV) sites within the zeolite framework. However, as has been found by C. P. Gordon et al. in said study, all sample TS-1 materials exhibited on contact with H₂¹⁷O₂ a characteristic solid-state 170 nuclear magnetic resonance signature that is indicative of the formation of peroxo species bridging titanium sites, certain signals being tentatively assigned to bridging

μ²η²-peroxo species as displayed in FIG. 1 of the present patent application. Further, it was found from density functional theory calculations that a cooperativity between said titanium sites enables propylene epoxidation via a low-energy reaction pathway with a key oxygen-transfer transition state similar to that of olefin epoxidation by peroxy acids. Therefore, it was suggested in said study that dinuclear titanium sites, rather than isolated titanium atoms in the framework, explain the high efficiency of TS-1 in propylene epoxidation with H₂O₂. R. Bai et al. Chemical Science 2022, vol. 13, p. 10868-10877, disclose a study on crystallization pathways of TS-1 zeolites in Chemical Science. The prepared TS-1 zeolites were examined by 170 solid-state NMR spectroscopy and the formation rate and stability of peroxo intermediates was studied.

WO 2023/094691 A1 specifically relates to catalysts for hydrogen peroxide activation.

There however remains a need for the provision of improved catalyst moldings for the activation of hydrogen peroxide, in particular with regard to their catalytic efficiency in epoxidation reactions, and more generally in oxidation reactions based on the conversion of hydrogen peroxide. In particular, there remains a need for an improved process for the activation of hydrogen peroxide where such improved catalyst moldings may be provided.

### DETAILED DESCRIPTION

Thus, it was an object of the present invention to provide an improved catalyst molding for hydrogen peroxide activation. Taking the above into account, it was a particular object of the present invention to provide a catalyst molding comprising a catalyst, wherein the catalyst displays a specific activation factor which is highly correlated to both the catalytic activity and selectivity of the catalyst and may thus discern it from existing materials in view of its improved catalytic performance. In addition, it was an object of the present invention to provide an improved process for the activation of hydrogen peroxide, wherein a catalyst molding comprising a catalyst, wherein the catalyst displays a specific activation factor, is used.

Surprisingly, it has been found that improved catalyst moldings can be provided comprising a catalyst, wherein the catalyst comprised in the catalyst molding displays a unique activation factor. In particular, it was surprisingly found that the multiplication product of the water adsorption and the concentration of bridging μ²η²-peroxo species per metal in the H₂O₂-activated catalyst, as determined by quantitative ¹⁷O NMR spectroscopy, of the catalyst which is comprised in the inventive catalyst molding provides a unique activation factor which is not only correlated to its catalytic activity, but furthermore clearly distinguishes the inventive catalyst moldings from those of the art. In addition, it was surprisingly found that an improved process for the activation of hydrogen peroxide can be provided in view of the aforementioned activation factor and the provision of improved catalyst moldings according to the present invention. Thus, it has been found that a catalyst molding can be provided having unique physical and chemical properties, and that said catalyst molding allows for an improved catalytic activity, in particular in the activation of hydrogen peroxide for oxidation, and in particular for epoxidation reactions such as the conversion of propylene and hydrogen peroxide to propylene oxide.

Therefore, the present invention relates to a catalyst molding for hydrogen peroxide activation, wherein the catalyst molding comprises a catalyst for hydrogen peroxide activation, said catalyst comprising Ti, Si, and O, wherein the catalyst comprised in the catalyst molding displays a water adsorption (W), preferably determined according to Reference Example 1.1, a concentration (C) of bridging μ²η²-peroxo species per Ti in the H₂O₂-activated catalyst as determined by quantitative ¹⁷O NMR spectroscopy, preferably determined according to Reference Example 1.3, and an activation factor (A) according to formula I, wherein the activation factor is in the range of from 10 to 75 mmol/mol;
wherein in accordance with formula I, the activation factor is the multiplication product of the water adsorption and the concentration of bridging μ²η²-peroxo species per Ti in the H₂O₂-activated catalyst:

A=W×C (I).

It is preferred that the catalyst molding further comprises one or more oxidic binders, wherein the one or more oxidic binders are more preferably selected from the group consisting of inorganic binders, wherein the one or more oxidic binders more preferably comprise one or more sources of a metal oxide and/or of a metalloid oxide, more preferably one or more sources of a metal oxide and/or of a metalloid oxide selected from the group consisting of silica, alumina, titania, zirconia, lanthana, magnesia, and mixtures and/or mixed oxides of two or more thereof, more preferably from the group consisting of silica, alumina, titania, zirconia, magnesia, silica-alumina mixed oxides, silica-titania mixed oxides, silicazirconia mixed oxides, silica-lanthana mixed oxides, silica-zirconia-lanthana mixed oxides, alumina-titania mixed oxides, alumina-zirconia mixed oxides, alumina-lanthana mixed oxides, alumina-zirconia-lanthana mixed oxides, titania-zirconia mixed oxides, and mixtures and/or mixed oxides of two or more thereof, more preferably from the group consisting of silica, alumina, silica-alumina mixed oxides, and mixtures of two or more thereof, wherein more preferably the one or more oxidic binders comprise one or more sources of silica, wherein more preferably the one or more binders consist of one or more sources of silica.

In the case where the catalyst molding further comprises one or more oxidic binders, it is preferred that the catalyst molding comprises the one or more oxidic binders, calculated as the oxide, in an amount in the range of from 1 to 90 wt.-%, more preferably of from 5 to 70 weight-%, more preferably of from 10 to 50 weight-%, more preferably of from 15 to 30 weight-%, more preferably of from 16 to 28 weight-%, more preferably of from 16 to 26 weight-%, more preferably of from 20 to 25 weight-%.

Further in the case where the catalyst molding further comprises one or more oxidic binders, it is preferred that from 95 to 100 weight-%, more preferably from 98 to 100 weight-%, more preferably from 99 to 100 weight-%, more preferably from 99.5 to 100 weight-%, more preferably from 99.9 to 100 weight-% of the catalyst molding consist of the catalyst and the one or more oxidic binders.

Within the meaning of the present invention, the term “binder” and in particular “oxidic binder” refers to materials which are not catalytically active in the epoxidation of olefins with hydrogen peroxide, i.e. which in any case do not display an activation factor falling within any of the ranges defined in the present patent application.

It is preferred that the catalyst molding exhibits a water adsorption in the range of from 1 to 15 wt.-%, more preferably of from 2 to 14 wt.-%, more preferably of from 2.5 to 11 wt.-%, more preferably of from 3 to 10 wt.-%, more preferably of from 4 to 9 wt.-%, more preferably of from 4.4 to 9 wt.-%, more preferably of from 4.4 to 8 wt.-%, more preferably of from 5 to 8 wt.-%, wherein the water adsorption is preferably determined when exposing the catalyst molding to a relative humidity of 85%, wherein the water adsorption is more preferably determined according to Reference Example 1.1. Alternatively, it is particularly preferred that the catalyst molding exhibits a water adsorption in the range of from 3 to 6.5 wt.-%, preferably of form 3.5 to 6 wt.-%, more preferably of from 4.4 to 5.5 wt.-%.

It is preferred that the catalyst molding displays a water adsorption (W), preferably determined according to Reference Example 1.1, a concentration (C) of bridging μ²η²-peroxo species per Ti in the H₂O₂-activated catalyst molding, as determined by quantitative 170 NMR spectroscopy, preferably determined according to Reference Example 1.3, and an activation factor (A) according to formula I, wherein the activation factor is in the range of from 10 to 75 mmol/mol;
wherein in accordance with formula I, the activation factor is the multiplication product of the water adsorption and the concentration of bridging μ²η²-peroxo species per Ti in the H₂O₂-activated catalyst molding:

A=W×C (I).

According to a first alternative, in the case where the catalyst molding displays an activation factor in the range of from 10 to 75 mmol/mol, it is preferred that the catalyst molding displays a concentration of bridging μ²η²-peroxo species per Ti in the H₂O₂-activated catalyst molding in the range of from 100 to 1,000 mmol/mol, more preferably from 200 to 900 mmol/mol, more preferably from 300 to 800 mmol/mol, more preferably from 350 to 700 mmol/mol, more preferably from 400 to 600 mmol/mol, more preferably from 420 to 550 mmol/mol.

Further in accordance with the first alternative, in the case where the catalyst molding displays an activation factor in the range of from 10 to 75 mmol/mol, it is preferred that the concentration (C) of bridging μ²η²-peroxo species per Ti in the H₂O₂-activated catalyst molding as determined by quantitative ¹⁷O NMR spectroscopy is the concentration which is determined at a time point T after having brought the catalyst molding into contact with H₂¹⁷O₂, wherein T is in the range of from 1 to 720 min after having brought the catalyst molding into contact with H₂¹⁷O₂, more preferably from 2 min to 480 min after having brought the catalyst molding into contact with H₂¹⁷O₂, more preferably from 4 to 240 min after having brought the catalyst molding into contact with H₂¹⁷O₂, more preferably from 6 to 120 min after having brought the catalyst molding into contact with H₂¹⁷O₂, more preferably from 8 to 60 min after having brought the catalyst molding into contact with H₂¹⁷O₂, more preferably from 10 to 30 min after having brought the catalyst molding into contact with H₂¹⁷O₂, more preferably from 12 to 20 min after having brought the catalyst molding into contact with H₂¹⁷O₂, and more preferably from 14 to 16 min after having brought the catalyst molding into contact with H₂¹⁷O₂, wherein more preferably T is 15 min after having brought the catalyst molding into contact with H₂¹⁷O₂.

Further in accordance with the first alternative, in the case where the catalyst molding displays an activation factor in the range of from 10 to 75 mmol/mol, it is preferred that the activation factor of the catalyst molding is in the range of from 12 to 70 mmol/mol, more preferably from 14 to 65 mmol/mol, more preferably from 16 to 60 mmol/mol, more preferably from 17 to 55 mmol/mol, more preferably from 18 to 50 mmol/mol, more preferably from 19 to 44 mmol/mol, more preferably from 20 to 39 mmol/mol, more preferably from 21 to 34 mmol/mol, more preferably from 22 to 29 mmol/mol, and more preferably from 23 to 26 mmol/mol.

According to a second alternative, it is preferred that the catalyst molding displays a concentration of bridging μ²η²-peroxo species per Ti in the H₂O₂-activated catalyst molding in the range of from 100 to 1,000 mmol/mol, wherein the concentration of bridging μ²η²-peroxo species per Ti in the H₂O₂-activated catalyst molding as determined by quantitative ¹⁷O NMR spectroscopy is the concentration which is determined at a time point T after having brought the catalyst molding into contact with H₂¹⁷O₂, wherein T is in the range of from 65 to 175 min.

Further in accordance with the second alternative, it is preferred that the catalyst molding displays a concentration of bridging μ²η²-peroxo species per Ti in the H₂O₂-activated catalyst molding as determined by quantitative ¹⁷O NMR spectroscopy, preferably determined according to Reference Example 1.2, in the range of from 200 to 900 mmol/mol, preferably from 300 to 800 mmol/mol, more preferably from 380 to 750 mmol/mol, more preferably from 420 to 700 mmol/mol, more preferably from 450 to 650 mmol/mol.

Further in accordance with the second alternative, it is preferred that T is in the range of from 75 to 165 min after having brought the catalyst molding into contact with H₂¹⁷O₂, more preferably from 85 min to 155 min after having brought the catalyst molding into contact with H₂¹⁷O₂, more preferably from 95 to 145 min after having brought the catalyst molding into contact with H₂¹⁷O₂, more preferably from 105 to 135 min after having brought the catalyst molding into contact with H₂¹⁷O₂, more preferably from 112 to 128 min after having brought the catalyst molding into contact with H₂¹⁷O₂, more preferably from 116 to 124 min after having brought the catalyst molding into contact with H₂¹⁷O₂, more preferably from 118 to 122 min after having brought the catalyst molding into contact with H₂¹⁷O₂, and more preferably from 119 to 121 min after having brought the catalyst molding into contact with H₂¹⁷O₂, wherein more preferably T is 120 min after having brought the catalyst molding into contact with H₂¹⁷O₂.

Further in accordance with the second alternative, it is preferred that the activation factor of the catalyst molding is in the range of from 12 to 70 mmol/mol, more preferably from 14 to 65 mmol/mol, more preferably from 16 to 60 mmol/mol, more preferably from 18 to 55 mmol/mol, more preferably from 19 to 50 mmol/mol, more preferably from 20 to 45 mmol/mol, more preferably from 21 to 40 mmol/mol, more preferably from 22 to 37 mmol/mol, more preferably from 23 to 35 mmol/mol, and more preferably from 24 to 34 mmol/mol.

It is preferred that the catalyst molding exhibits a BET specific surface area in the range of from 50 to 700 m²/g, more preferably of from 100 to 500 m²/g, more preferably of from 150 to 475 m²/g, more preferably of from 200 to 450 m²/g, more preferably of from 250 to 425 m2/g, more preferably of from 300 to 400 m²/g, more preferably of from 320 to 400 m²/g, wherein the BET specific surface area is preferably determined according to Reference Example 1.5.

It is preferred that the catalyst molding exhibits a total pore volume in the range of from 0.2 to 1.5 g/ml, more preferably in the range of from 0.4 to 1.4 g/ml, more preferably in the range of from 0.4 to 1.3 g/ml, more preferably in the range of from 0.5 to 1.1 ml/g, more preferably in the range of from 0.7 to 1.0 ml/g, wherein the total pore volume is preferably determined according to Reference Example 1.11.

It is preferred that the catalyst molding exhibits an average crush strength in the range of from 3 to 30 N, more preferably in the range of from 4 to 25 N, more preferably in the range of from 5 to 20 N, more preferably in the range of from 5 to 15 N, wherein the average crush strength is preferably determined according to Reference Example 1.8.

It is preferred that the catalyst molding has a sodium content, calculated as Na₂O, in the range of from 0 to 0.5 weight-%, more preferably of from 0 to 0.2 weight-%, more preferably of from 0 to 0.15 weight-%, more preferably of from 0 to 0.14 weight-%, more preferably in the range of from 0 to 0.1 weight-%, more preferably of less than 0.1 weight-%, more preferably of from 0 to 0.08 weight-%, based on the weight of the catalyst molding.

It is preferred that the catalyst molding exhibits an acid site density in the range of from 1 to 1000 μmol/g, preferably in the range of from 5 to 500 μmol/g, more preferably in the range of from 10 to 100 μmol/g, at a temperature below 250 °C, determined according to Reference Example 1.9.

It is preferred that the catalyst molding exhibits a propylene oxide activity of at least 2.0 weight-%, preferably in the range of from 3.0 to 15.0 weight-%, more preferably in the range of from 3.5 to 10.0 weight-%, more preferably in the range of from 4.0 to 7.5 weight-%, more preferably in the range of from 4.5 to 6.5 weight-%, more preferably in the range of from 5.5 to 6.3 weight-%, preferably determined as described in Reference Example 1.6.

It is preferred that the catalyst molding is in the form of a strand, more preferably having a cross-sectional profile, wherein the cross-sectional profile more preferably is hexagonal, rectangular, quadratic, triangular, oval, or circular, more preferably circular, wherein the cross-sectional profile more preferably has a diameter in the range of from 0.1 to 10 mm, more preferably in the range of from 0.2 to 7 mm, more preferably in the range of from 0.5 to 5 mm, more preferably in the range of from 1.0 to 3.0 mm, more preferably in the range of from 1.5 to 2.0 mm.

It is preferred that the catalyst molding is an extrudate.

It is preferred that the catalyst comprised in the catalyst molding displays a water adsorption in the range of from 1 to 10 wt.-%, preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%. Alternatively, it is particularly preferred that the catalyst comprised in the catalyst molding displays a water adsorption in the range of from 3 to 6.5 wt.-%, more preferably from 3.2 to 4.5 wt.-%, more preferably from 3.4 to 4.1 wt.-%. It is noted that for a water adsorption of x wt.-%, said value corresponds to x % g/g=(x/100) g/g=W. Accordingly, by way of example, a water adsorption of 1 wt.-%=1% g/g=0.01 g/g=W. Further and independently thereof, it is preferred that the catalyst comprised in the catalyst molding displays a concentration of bridging μ²η²-peroxo species per Ti in the H₂O₂-activated catalyst in the range of from 150 to 1,000 mmol/mol, preferably from 100 to 800 mmol/mol, more preferably from 150 to 750 mmol/mol, more preferably from 200 to 700 mmol/mol, more preferably from 250 to 650 mmol/mol, more preferably from 300 to 600 mmol/mol, more preferably from 350 to 550 mmol/mol, and more preferably from 400 to 500 mmol/mol. Further and independently thereof, it is preferred that the concentration (C) of bridging μ²η²-peroxo species per Ti in the H₂O₂-activated catalyst as determined by quantitative ¹⁷O NMR spectroscopy is the concentration which is determined at a time point T after having brought the catalyst, which is comprised in the catalyst molding, into contact with H₂¹⁷O₂, wherein T is in the range of from 1 to 720 min after having brought the catalyst into contact with H₂¹⁷O₂, more preferably from 2 min to 480 min after having brought the catalyst into contact with H₂¹⁷O₂, more preferably from 4 to 240 min after having brought the catalyst into contact with H₂¹⁷O₂, more preferably from 6 to 120 min after having brought the catalyst into contact with H₂¹⁷O₂, more preferably from 8 to 60 min after having brought the catalyst into contact with H₂¹⁷O₂, more preferably from 10 to 30 min after having brought the catalyst into contact with H₂¹⁷O₂, more preferably from 12 to 20 min after having brought the catalyst into contact with H₂¹⁷O₂, and more preferably from 14 to 16 min after having brought the catalyst into contact with H₂¹⁷O₂, wherein more preferably T is 15 min after having brought the catalyst into contact with H₂¹⁷O₂. Further and independently thereof, it is preferred that the activation factor of the catalyst comprised in the catalyst molding is in the range of from 11 to 65 mmol/mol, preferably from 13 to 55 mmol/mol, more preferably from 15 to 50 mmol/mol, more preferably from 18 to 45 mmol/mol, more preferably from 20 to 40 mmol/mol, more preferably from 21 to 39 mmol/mol, more preferably from 22 to 37 mmol/mol, more preferably from 23 to 35 mmol/mol, more preferably from 24 to 32 mmol/mol, and more preferably from 25 to 30 mmol/mol.

Alternatively, it is preferred that the catalyst comprised in the catalyst molding displays a concentration of bridging μ²η²-peroxo species per Ti in the H₂O₂-activated catalyst in the range of from 125 to 750 mmol/mol, wherein the concentration of bridging μ²η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min. Further and independently thereof, it is preferred that the catalyst comprised in the catalyst molding displays a water adsorption in the range of from 1 to 7.9 wt.-%, more preferably from 3 to 7.5 wt.-%, more preferably from 4 to 7 wt.-%, more preferably from 4.5 to 6.5 wt.-%. Alternatively, it is particularly preferred that the catalyst comprised in the catalyst molding displays a water adsorption in the range of from 3 to 6.5 wt.-%, more preferably from 3.2 to 4.5 wt.-%, more preferably from 3.4 to 4.1 wt.-%. Further and independently thereof, it is preferred that the catalyst comprised in the catalyst molding displays a concentration of bridging μ² n 2-peroxo species per Ti in the H₂O₂-activated catalyst as determined by quantitative ₁₇O NMR spectroscopy, more preferably determined according to Reference Example 1.3, in the range of from 200 to 725 mmol/mol, preferably from 250 to 700 mmol/mol, more preferably from 300 to 680 mmol/mol, more preferably from 350 to 660 mmol/mol, more preferably from 400 to 640 mmol/mol, more preferably from 450 to 620 mmol/mol, and more preferably from 500 to 600 mmol/mol. Further and independently thereof, it is preferred that T is in the range of from 75 to 165 min after having brought the catalyst into contact with H₂¹⁷O₂, more preferably from 85 min to 155 min after having brought the catalyst into contact with H₂¹⁷O₂, more preferably from 95 to 145 min after having brought the catalyst into contact with H₂¹⁷O₂, more preferably from 105 to 135 min after having brought the catalyst into contact with H₂¹⁷O₂, more preferably from 112 to 128 min after having brought the catalyst into contact with H₂¹⁷O₂, more preferably from 116 to 124 min after having brought the catalyst into contact with H₂¹⁷O₂, more preferably from 118 to 122 min after having brought the catalyst into contact with H₂¹⁷O₂, and more preferably from 119 to 121 min after having brought the catalyst into contact with H₂¹⁷O₂, wherein more preferably T is 120 min after having brought the catalyst into contact with H₂¹⁷O₂. Further and independently thereof, it is preferred that the activation factor of the catalyst comprised in the catalyst molding is in the range of from 11 to 70 mmol/mol, preferably from 12 to 62 mmol/mol, more preferably in the range of from 13 to 60 mmol/mol, more preferably from 14 to 59 mmol/mol, more preferably from 16 to 54 mmol/mol, more preferably from 18 to 49 mmol/mol, more preferably from 20 to 44 mmol/mol, more preferably from 21 to 39 mmol/mol, more preferably from 22 to 34 mmol/mol, more preferably from 23 to 31 mmol/mol, and more preferably from 24 to 28 mmol/mol.

It is preferred that the catalyst comprised in the catalyst molding of the present invention displays a XANES spectrum having a ratio of the intensity of the signal at 4987 eV to the intensity of the signal at 4992 eV in the range of from 0.95:1 to 1.07:1, more preferably of from 0.97:1 to 1.07:1, more preferably in the range of from 0.99:1 to 1.07:1, more preferably in the range of from 1.01:1 to 1.07:1, more preferably in the range of from 1.03:1 to 1.07:1, and more preferably in the range of from 1.05:1 to 1.07:1, wherein the XANES spectrum is more preferably determined according Reference Example 1.2.

It is preferred that the catalyst comprised in the catalyst molding of the present invention has a BET specific surface area in the range of from 350 to 475 m²/g, more preferably from 370 to 460 m²/g, more preferably from 390 to 445 m²/g, wherein the BET specific surface area is preferably determined according to Reference Example 1.5.

It is preferred that the catalyst comprised in the catalyst molding of the present invention comprises from 0.2 to 5 weight-%, preferably in the range of from 0.5 to 4 weight-%, more preferably in the range of from 0.7 to 3 weight-%, more preferably of from 0.7 to 2.5 weight-%, more preferably from 0.8 to 2.0 weight-%, more preferably from 1.0 to 1.9 weight-%, more preferably from 1.0 to 1.8 weight-%, more preferably from 1.1 to 1.3 weight-%, of Ti, calculated as the element and based on the total weight of the catalyst comprised in the catalyst molding.

It is preferred that the catalyst comprised in the catalyst molding of the present invention comprises from 0 to 1 weight-%, preferably from 0 to 0.1 weight-%, more preferably from 0 to 0.01 weight-%, more preferably from 0 to 0.001 weight-%, of B, calculated as the element and based on the total weight of the catalyst comprised in the catalyst molding.

It is preferred that the catalyst comprised in the catalyst molding of the present invention comprises from 0 to 0.1 weight-%, preferably from 0 to 0.08 weight-%, of Na, calculated as the element and based on the total weight of the catalyst comprised in the catalyst molding.

It is preferred that the catalyst comprised in the catalyst molding of the present invention comprises from 0 to 1 weight-%, preferably from 0 to 0.1 weight-%, more preferably from 0 to 0.01 weight-%, more preferably from 0 to 0.001 weight-%, of Ge, calculated as the element and based on the total weight of the catalyst comprised in the catalyst molding.

It is preferred that the catalyst comprised in the catalyst molding of the present invention comprises from 0 to 1 weight-%, preferably from 0 to 0.5 weight-%, more preferably from 0 to 0.2 weight-%, more preferably from 0 to 0.1 weight-%, more preferably from 0 to 0.01 weight-%, more preferably from 0 to 0.009 weight-%, more preferably from 0 to 0.005 weight-%, more preferably from 0 to 0.001 weight-%, of C, calculated as the element and based on the total weight of the catalyst comprised in the catalyst molding.

It is preferred that the catalyst comprised in the catalyst molding of the present invention comprises a content of one or more of Fe, Co, Ni, and Cu, calculated as Fe₂O₃, Co₂O₃, NiO, and CuO, respectively, in the range of from 0 to 0.1 weight-%, more preferably in the range of from 0 to 0.07 weight-%, more preferably in the range of from 0 to 0.05 weight-%, more preferably in the range of from 0 to 0.02 weight-%, based on the weight of the catalyst which is comprised in the catalyst molding. Alternatively, it is preferred that the catalyst comprised in the catalyst molding of the present invention comprises a content of one or more of Fe, Co, Ni, and Cu, calculated as the element, respectively, in the range of from 0 to 0.1 weight-%, more preferably in the range of from 0 to 0.07 weight-%, more preferably in the range of from 0 to 0.05 weight-%, more preferably in the range of from 0 to 0.02 weight-%, based on the weight of the catalyst which is comprised in the catalyst molding.

It is preferred that the catalyst comprised in the catalyst molding of the present invention exhibits a propylene oxide activity of at least 2.0 weight-%, preferably in the range of from 3.0 to 15.0 weight-%, more preferably in the range of from 5.0 to 14.0 weight-%, more preferably in the range of from 9.0 to 13.0 weight-%, preferably determined as described in Reference Example 1.6.

Optionally, the catalyst can further comprise one or more metals selected from the group consisting of K, Zn, Cd, Sn, La, and Ba, including mixtures of two or more thereof, preferably from the group consisting of Zn, Cd, Sn, La, and Ba, including mixtures of two or more thereof.

It is preferred that from 95 to 100 wt.-% of the catalyst, which is comprised in the catalyst molding, consists of Ti, Si, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

It is preferred that from 95 to 100 wt.-% of the catalyst, which is comprised in the catalyst molding, consists of Ti, Si, O, and H, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

It is preferred that from 95 to 100 weight-%, preferably from 98 to 100 weight-%, more preferably from 99 to 100 weight-%, more preferably from at least 99.5 to 100 weight-%, more preferably from 99.9 to 100 weight-% of the one or more oxidic binders comprised in the catalyst molding consist of Si and O.

It is preferred that the catalyst, which is comprised in the catalyst molding, comprises, more preferably consists of, a zeolitic material having a framework structure comprising Si, Ti, and O.

In case where the catalyst, which is comprised in the catalyst molding, comprises a zeolitic material having a framework structure comprising Si, Ti, and O, it is preferred that the zeolitic material having an Si: Ti molar ratio in the range of from 1 to 250, more preferably in the range of from 10 to 150, more preferably in the range of from 20 to 95, more preferably in the range of from 30 to 75, more preferably in the range of from 35 to 70, more preferably in the range of from 40 to 65, more preferably in the range of from 45 to 60, more preferably in the range of from 50 to 55.

Furthermore, and independently thereof, in case where the catalyst, which is comprised in the catalyst molding, comprises a zeolitic material having a framework structure comprising Si, Ti, and O, it is preferred that the zeolitic material has a framework structure type selected from the group consisting of MFI, MEL, MWW, ITH, IWR, IMF, SVY, FER, SVR, and intergrowth structures of two or more thereof, more preferably selected from the group consisting of MFI, MEL, MWW, ITH, and IWR, and intergrowth structures of two or more thereof, more preferably selected from the group consisting of MFI, MEL, and intergrowth structures thereof, wherein the zeolitic material more preferably has an MFI-type framework structure. Furthermore, and independently thereof, it is preferred that the zeolitic material is a TS-1 zeolite.

Furthermore, and independently thereof, the zeolitic material can optionally further comprise one or more metals selected from the group consisting of K, Zn, Cd, Sn, La, and Ba, including mixtures of two or more thereof, preferably from the group consisting of Zn, Cd, Sn, La, and Ba, including mixtures of two or more thereof, wherein the one or more metals are more preferably contained in the pores of the zeolitic material.

Furthermore, and independently thereof, it is preferred that from 95 to 100 wt.-% of the zeolitic material consists of Ti, Si, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore, and independently thereof, it is preferred that from 95 to 100 wt.-% of the zeolitic material consists of Ti, Si, O, and H, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore, and independently thereof, it is preferred that the zeolitic material has a crystallinity in the range of from 50 to 110 weight-%, preferably from 50 to 100 weight-%, more preferably from 75 to 100 weight-%, more preferably from 80 to 100 weight-%, and more preferably from 90 to 100 weight-%, wherein the crystallinity is preferably determined as described in Reference Example 1.4.

The present invention also relates to a method for preparing a catalyst molding, preferably for preparing a catalyst molding according to any one of the embodiments disclosed herein, the method comprising
(a) providing a catalyst for hydrogen peroxide activation, as defined in any of the particular and preferred embodiments of the present invention;
(b) mixing the catalyst provided in step (a) with one or more binders;
(c) optionally kneading of the mixture obtained in step (b);
(d) molding of the mixture obtained in step (b) or (c) to obtain a precursor of the catalyst molding;
(e) optionally preparing a mixture comprising the precursor of the catalyst molding obtained from (d) and water, and subjecting the mixture to a water treatment under hydrothermal conditions, obtaining a water-treated precursor of the catalyst molding;
(f) optionally drying of the precursor of the catalyst molding obtained in step (d) or of the water-treated precursor of the catalyst molding obtained in (e); and
(g) calcining of the one or more catalyst moldings obtained in step (d), (e) or (f).

It is preferred that providing the catalyst in (a) comprises selecting the catalyst among catalysts comprising Ti, Si, and O, and displaying
a water adsorption (W), preferably determined according to Reference Example 1.1, and a concentration (C) of bridging μ²η²-peroxo species per Ti in the H₂O₂-activated catalyst as determined by quantitative ¹⁷O NMR spectroscopy, preferably according to Reference Example 1.3;
wherein the catalyst is selected by calculating an activation factor (A) in accordance with formula I for each of the catalysts, and selecting a catalyst displaying an activation factor in the range of from 10 to 75 mmol/mol, wherein the activation factor is the multiplication product of the water adsorption and the concentration of bridging μ²η²-peroxo species per Ti in the H₂O₂-activated catalyst:

A=W×C (I).

In case where providing the catalyst in (a) comprises selecting the catalyst among catalysts comprising Ti, Si, and O, it is preferred that providing the catalyst in (a) comprises selecting the catalyst among catalysts displaying a water adsorption in the range of from 1 to 10 wt.-%, preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%. Alternatively, it is particularly preferred that providing the catalyst in (a) comprises selecting the catalyst among catalysts displaying a water adsorption in the range of from 3 to 6.5 wt.-%, more preferably from 3.2 to 4.5 wt.-%, more preferably from 3.4 to 4.1 wt.-%. Furthermore and independently thereof, it is preferred that providing the catalyst in (a) comprises selecting the catalyst among catalysts displaying a concentration of bridging μ²η²-peroxo species per Ti in the H₂O₂-activated catalyst in the range of from 150 to 1,000 mmol/mol, preferably from 100 to 800 mmol/mol, more preferably from 150 to 750 mmol/mol, more preferably from 200 to 700 mmol/mol, more preferably from 250 to 650 mmol/mol, more preferably from 300 to 600 mmol/mol, more preferably from 350 to 550 mmol/mol, and more preferably from 400 to 500 mmol/mol. Furthermore and independently thereof, it is preferred that the catalyst is selected by calculating an activation factor (A) for each of the catalysts, and selecting a catalyst displaying an activation factor in the range of from 11 to 65 mmol/mol, preferably from 13 to 55 mmol/mol, more preferably from 15 to 50 mmol/mol, more preferably from 18 to 45 mmol/mol, more preferably from 20 to 40 mmol/mol, more preferably from 21 to 39 mmol/mol, more preferably from 22 to 37 mmol/mol, more preferably from 23 to 35 mmol/mol, more preferably from 24 to 32 mmol/mol, and more preferably from 25 to 30 mmol/mol. Furthermore and independently thereof, it is preferred that the concentration (C) of bridging μ²η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 1 to 720 min after having brought the catalyst into contact with H₂¹⁷O₂, more preferably from 2 min to 480 min after having brought the catalyst into contact with H₂¹⁷O₂, more preferably from 4 to 240 min after having brought the catalyst into contact with H₂¹⁷O₂, more preferably from 6 to 120 min after having brought the catalyst into contact with H₂¹⁷O₂, more preferably from 8 to 60 min after having brought the catalyst into contact with H₂¹⁷O₂, more preferably from 10 to 30 min after having brought the catalyst into contact with H₂¹⁷O₂, more preferably from 12 to 20 min, and more preferably from 14 to 16 min after having brought the catalyst into contact with H₂¹⁷O₂, wherein more preferably T is 15 min after having brought the catalyst into contact with H₂¹⁷O₂.

Alternatively, it is preferred that providing the catalyst in (a) comprises selecting the catalyst among catalysts displaying a concentration (C) of bridging μ²η²-peroxo species per Ti in the H₂O₂-activated catalyst as determined by quantitative ¹⁷O NMR spectroscopy in the range of from 125 to 750 mmol/mol, wherein the concentration (C) of bridging μ²η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min. Further and independently thereof, it is preferred that providing the catalyst in (a) comprises selecting the catalyst among catalysts displaying a water adsorption in the range of from 1 to 7.9 wt.-%, more preferably from 3 to 7.5 wt.-%, more preferably from 4 to 7 wt.-%, more preferably from 4.5 to 6.5 wt.-%. Alternatively, it is particularly preferred that providing the catalyst in (a) comprises selecting the catalyst among catalysts displaying a water adsorption in the range of from 3 to 6.5 wt.-%, more preferably from 3.2 to 4.5 wt.-%, more preferably from 3.4 to 4.1 wt.-%. Further and independently thereof, it is preferred that providing the catalyst in (a) comprises selecting the catalyst among catalysts displaying a concentration (C) of bridging μ²η²-peroxo species per Ti in the H₂O₂-activated catalyst as determined by quantitative ¹⁷O NMR spectroscopy, more preferably determined according to Reference Example 1.3, in the range of from 200 to 725 mmol/mol, preferably from 250 to 700 mmol/mol, more preferably from 300 to 680 mmol/mol, more preferably from 350 to 660 mmol/mol, more preferably from 400 to 640 mmol/mol, more preferably from 450 to 620 mmol/mol, and more preferably from 500 to 600 mmol/mol. Further and independently thereof, it is preferred that T is in the range of from 75 to 165 min after having brought the catalyst into contact with H₂¹⁷O₂, more preferably from 85 min to 155 min after having brought the catalyst into contact with H₂¹⁷O₂, more preferably from 95 to 145 min after having brought the catalyst into contact with H₂¹⁷O₂, more preferably from 105 to 135 min after having brought the catalyst into contact with H₂¹⁷O₂, more preferably from 112 to 128 min after having brought the catalyst into contact with H₂¹⁷O₂, more preferably from 116 to 124 min after having brought the catalyst into contact with H₂¹⁷O₂, more preferably from 118 to 122 min after having brought the catalyst into contact with H₂¹⁷O₂, and more preferably from 119 to 121 min after having brought the catalyst into contact with H₂¹⁷O₂, wherein more preferably T is 120 min after having brought the catalyst into contact with H₂¹⁷O₂. Further and independently thereof, it is preferred that the activation factor (A) is in the range of from 11 to 70 mmol/mol, preferably from 12 to 62 mmol/mol, more preferably in the range of from 13 to 60 mmol/mol, more preferably from 14 to 59 mmol/mol, more preferably from 16 to 54 mmol/mol, more preferably from 18 to 49 mmol/mol, more preferably from 20 to 44 mmol/mol, more preferably from 21 to 39 mmol/mol, more preferably from 22 to 34 mmol/mol, more preferably from 23 to 31 mmol/mol, and more preferably from 24 to 28 mmol/mol.

It is preferred that providing the catalyst in (a) comprises selecting the catalyst among catalysts comprising from 0 to 1 weight-%, more preferably from 0 to 0.1 weight-%, more preferably from 0 to 0.01 weight-%, more preferably from 0 to 0.001 weight-%, of B, calculated as the element and based on the total weight of the catalyst.

It is preferred that providing the catalyst in (a) comprises selecting the catalyst among catalysts comprising from 0 to 0.1 weight-%, preferably from 0 to 0.08 weight-%, of Na, calculated as the element and based on the total weight of the catalyst.

It is preferred that providing the catalyst in (a) comprises selecting the catalyst among catalysts comprising from 0 to 1 weight-%, more preferably from 0 to 0.1 weight-%, more preferably from 0 to 0.01 weight-%, more preferably from 0 to 0.001 weight-%, of Ge, calculated as the element and based on the total weight of the catalyst.

It is preferred that providing the catalyst in (a) comprises selecting the catalyst among catalysts comprising from 0 to 1 weight-%, more preferably from 0 to 0.5 weight-%, more preferably from 0 to 0.2 weight-%, more preferably from 0 to 0.1 weight-%, more preferably from 0 to 0.01 weight-%, more preferably from 0 to 0.009 weight-%, more preferably from 0 to 0.005 weight-%, more preferably from 0 to 0.001 weight-%, of C, calculated as the element and based on the total weight of the catalyst.

It is preferred that providing the catalyst in (a) comprises selecting the catalyst among catalysts exhibiting a propylene oxide activity of at least 2.0 weight-%, more preferably in the range of from 3.0 to 15.0 weight-%, more preferably in the range of from 5.0 to 14.0 weight-%, more preferably in the range of from 9.0 to 13.0 weight-%, more preferably determined as described in Reference Example 1.6.

It is preferred that the one or more binders in (b) are selected from the group consisting of inorganic binders, wherein the one or more binders more preferably comprise one or more sources of a metal oxide and/or of a metalloid oxide, more preferably one or more sources of a metal oxide and/or of a metalloid oxide selected from the group consisting of silica, alumina, titania, zirconia, lanthana, magnesia, and mixtures and/or mixed oxides of two or more thereof, more preferably from the group consisting of silica, alumina, titania, zirconia, magnesia, silica-alumina mixed oxides, silica-titania mixed oxides, silica-zirconia mixed oxides, silica-lanthana mixed oxides, silica-zirconia-lanthana mixed oxides, alumina-titania mixed oxides, alumina-zirconia mixed oxides, alumina-lanthana mixed oxides, alumina-zirconia-lanthana mixed oxides, titania-zirconia mixed oxides, and mixtures and/or mixed oxides of two or more thereof, more preferably from the group consisting of silica, alumina, silica-alumina mixed oxides, and mixtures of two or more thereof, wherein more preferably the one or more binders in (b) comprise one or more sources of silica, wherein more preferably the one or more binders in (b) consist of one or more sources of silica, wherein the one or more sources of silica preferably comprise one or more compounds selected from the group consisting of fumed silica, colloidal silica, silica-alumina, colloidal silica-alumina, and mixtures of two or more thereof, more preferably one or more compounds selected from the group consisting of fumed silica, colloidal silica, and mixtures thereof, wherein more preferably the one or more binders in (b) consist of colloidal silica.

It is preferred that step (b) further comprises mixing the zeolitic material and the one or more binders with a solvent system, wherein the solvent system comprises one or more solvents, wherein more preferably the solvent system comprises one or more hydrophilic solvents, the hydrophilic solvents preferably being selected from the group consisting of polar solvents, more preferably from the group consisting of polar protic solvents, wherein more preferably the solvent system comprises one or more polar protic solvents selected from the group consisting of water, alcohols, carboxylic acids, and mixtures of two or more thereof, more preferably from the group consisting of water, C₁-C₅ alcohols, C₁-C₅ carboxylic acids, and mixtures of two or more thereof, more preferably from the group consisting of water, C₁-C₄ alcohols, C₁-C₄ carboxylic acids, and mixtures of two or more thereof, more preferably from the group consisting of water, C₁-C₃ alcohols, C₁-C₃ carboxylic acids, and mixtures of two or more thereof, more preferably from the group consisting of water, methanol, ethanol, propanol, formic acid, acetic acid, and mixtures of two or more thereof, more preferably from the group consisting of water, ethanol, acetic acid, and mixtures of two or more thereof, wherein more preferably the solvent system comprises water and/or ethanol, and wherein more preferably the solvent system comprises water, wherein even more preferably the solvent system consists of water.

It is preferred that step (b) further comprises mixing the zeolitic material and the one or more binders with one or more agents, preferably one or more pore forming agents and/or lubricants and/or plasticizers, wherein the one or more agents comprise, preferably consist of, one or more of water, alcohols, organic polymers, carbohydrates, graphite, plant additives, and mixtures of two or more thereof, preferably one or more of water, alcohols, organic polymers, polysaccharides, carbohydrates, graphite, plant additives, and mixtures of two or more thereof, more preferably one or more of water, polymeric vinyl compounds, celluloses, cellulose derivatives, polymannoses, polymannose derivatives, starches, polyalkylene oxides, polystyrenes, polyacrylates, polymethacrylates, polyolefins, polyamides, polyesters, and mixtures of two or more thereof, more preferably one or more of water, polymeric vinyl compounds, polyalkylene oxides, polyacrylates, polyolefins, polystyrenes, polyamides, polyesters, celluloses, cellulose derivatives, polymannoses, polymannose derivatives, and mixtures of two or more thereof, more preferably one or more of water, polystyrene, C₂-C₃ polyalkylene oxides, polymeric vinyl compounds, cellulose, hydroxymethylcellulose, methoxy cellulose, ethoxy cellulose, polymannose at least partially derivatized with galactose, and mixtures of two or more thereof, more preferably one or more of water, polystyrene, polyethylene oxide, a polyvinyl acetate, hydroxymethylcellulose, methoxy cellulose, ethoxy cellulose, a cellulose, a galactomannan, and mixtures of two or more thereof, wherein the one or more agents more preferably comprise, more preferably consist of, one or more of water, polystyrene, polyethylene oxide, hydroxymethylcellulose, methoxy cellulose, ethoxy cellulose, and mixtures of two or more thereof.

It is preferred that the method further comprises after (d) and prior to (e) drying the precursor of the catalyst molding obtained from (d), obtaining a dried precursor of the catalyst molding, wherein the method preferably further comprises calcining the dried precursor of the catalyst molding, wherein calcining is preferably performed at a temperature ranging from 350 to 850 °C, more preferably from 400 to 700 °C, more preferably from 450 to 650 °C, and more preferably from 475 to 600 °C.

It is preferred that the water treatment according to (e) is performed with a water containing solvent system and/or with an aqueous solution, wherein more preferably the hydrothermal treatment is performed with deionized water.

It is preferred that the water treatment according to (e) comprises a temperature of the mixture in the range of from 130 to 160 °C, preferably in the range of from 140 to 150 °C.

It is preferred that the water treatment according to (e) is carried out under autogenous pressure, preferably in an autoclave.

It is preferred that the water treatment according to (e) is carried out for 6 to 15 h, preferably for 7 to 10 h.

It is preferred that in the mixture prepared in (e), the weight ratio of the precursor of the catalyst molding obtained from (d) relative to the water is in the range of from 1:25 to 1:10, preferably in the range of from 1:21 to 1:14.

It is preferred that, after (d) and prior to (e), preferably after the drying as defined hereinabove, more preferably after the calcining as defined hereinabove, the water-treated precursor of the molding is separated from the mixture obtained from (d), wherein separating preferably comprises subjecting the mixture obtained from (d) to filtration or centrifugation, wherein more preferably, separating further comprises washing the water-treated precursor of the molding at least once with a liquid solvent system, wherein the liquid solvent system preferably comprises one or more of water, an alcohol, and a mixture of two or more thereof, wherein the water-treated precursor of the molding is more preferably washed with water.

It is preferred that the calcining according to (g) of the dried molding obtained in step (f) is performed at a temperature ranging from 350 to 850 °C, more preferably from 400 to 700 °C, more preferably from 450 to 650 °C, and more preferably from 475 to 600 °C.

The present invention also relates to a catalyst molding comprising a catalyst for hydrogen peroxide activation according to any one of the particular and preferred embodiments of the present invention, wherein the catalyst molding is preferably obtainable or obtained by a method according to any one of the particular and preferred embodiments of the present invention.

The present invention also relates to a process for the activation of hydrogen peroxide comprising:
(1) providing a reactor comprising a catalyst molding for hydrogen peroxide activation according to any of the particular and preferred embodiments of the present invention;
(2) contacting the catalyst molding provided in (1) with hydrogen peroxide.

It is preferred that providing the catalyst molding in (1) comprises selecting the catalyst, which is comprised in the catalyst molding, among catalysts comprising Ti, Si, and O, and displaying
a water adsorption (W), preferably determined according to Reference Example 1.1, and a concentration (C) of bridging μ²η²-peroxo species per Ti in the H₂O₂-activated catalyst as determined by quantitative ¹⁷O NMR spectroscopy, preferably according to Reference Example 1.3;
wherein the catalyst, which is comprised in the catalyst molding, is selected by calculating an activation factor (A) in accordance with formula I for each of the catalysts, and selecting a catalyst displaying an activation factor in the range of from 10 to 75 mmol/mol, wherein the activation factor is the multiplication product of the water adsorption and the concentration of bridging μ²η²-peroxo species per Ti in the H₂O₂-activated catalyst:

A=W×C (I).

In case where providing the catalyst molding in (1) comprises selecting the catalyst among catalysts comprising Ti, Si, and O, wherein the catalyst, which is comprised in the catalyst molding, is selected by calculating an activation factor (A) in accordance with formula I for each of the catalysts, it is preferred that providing the catalyst molding in (1) comprises selecting the catalyst, which is comprised in the catalyst molding, among catalysts displaying a water adsorption in the range of from 1 to 10 wt.-%, more preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%, and more preferably from 5 to 6 wt.-%. Alternatively, it is particularly preferred that providing the catalyst molding in (1) comprises selecting the catalyst, which is comprised in the catalyst molding, among catalysts displaying a water adsorption in the range of from 3 to 6.5 wt.-%, more preferably from 3.2 to 4.5 wt.-%, more preferably from 3.4 to 4.1 wt.-%. Further and independently thereof, in case where providing the catalyst molding in (1) comprises selecting the catalyst, which is comprised in the catalyst molding, among catalysts comprising Ti, Si, and O, wherein the catalyst is selected by calculating an activation factor (A) in accordance with formula I for each of the catalysts, it is preferred that providing the catalyst molding in (1) comprises selecting the catalyst, which is comprised in the catalyst molding, among catalysts displaying a concentration of bridging μ²η²-peroxo species per Ti in the H₂O₂-activated catalyst in the range of from 150 to 1,000 mmol/mol, preferably from 100 to 800 mmol/mol, more preferably from 150 to 750 mmol/mol, more preferably from 200 to 700 mmol/mol, more preferably from 250 to 650 mmol/mol, more preferably from 300 to 600 mmol/mol, more preferably from 350 to 550 mmol/mol, and more preferably from 400 to 500 mmol/mol. Furthermore and independently thereof, in case where providing the catalyst in (a) comprises selecting the catalyst, which is comprised in the catalyst molding, among catalysts comprising Ti, Si, and O, wherein the catalyst is selected by calculating an activation factor (A) in accordance with formula I for each of the catalysts, it is preferred that the catalyst is selected by calculating an activation factor (A) for each of the catalysts, and selecting a catalyst displaying an activation factor in the range of from 11 to 65 mmol/mol, preferably from 13 to 55 mmol/mol, more preferably from 15 to 50 mmol/mol, more preferably from 18 to 45 mmol/mol, more preferably from 20 to 40 mmol/mol, more preferably from 21 to 39 mmol/mol, more preferably from 22 to 37 mmol/mol, more preferably from 23 to 35 mmol/mol, more preferably from 24 to 32 mmol/mol, and more preferably from 25 to 30 mmol/mol.

Furthermore, and independently thereof, in case where providing the catalyst molding in (1) comprises selecting the catalyst, which is comprised in the catalyst molding, among catalysts comprising Ti, Si, and O, wherein the catalyst is selected by calculating an activation factor (A) in accordance with formula I for each of the catalysts, it is preferred that the concentration (C) of bridging μ²η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 1 to 720 min after having brought the catalyst into contact with H₂¹⁷O₂, more preferably from 2 min to 480 min after having brought the catalyst into contact with H₂¹⁷O₂, more preferably from 4 to 240 min after having brought the catalyst into contact with H₂¹⁷O₂, more preferably from 6 to 120 min after having brought the catalyst into contact with H₂¹⁷O₂, more preferably from 8 to 60 min after having brought the catalyst into contact with H₂¹⁷O₂, more preferably from 10 to 30 min after having brought the catalyst into contact with H₂¹⁷O₂, more preferably from 12 to 20 min after having brought the catalyst into contact with H₂¹⁷O₂, and more preferably from 14 to 16 min after having brought the catalyst into contact with H₂¹⁷O₂, wherein more preferably T is 15 min after having brought the catalyst into contact with H₂¹⁷O₂.

Alternatively, in case where providing the catalyst molding in (1) comprises selecting the catalyst, which is comprised in the catalyst molding, among catalysts comprising Ti, Si, and O, wherein the catalyst is selected by calculating an activation factor (A) in accordance with formula I for each of the catalysts, it is preferred that providing the catalyst molding in (1) comprises selecting the catalyst, which is comprised in the catalyst molding, among catalysts displaying a concentration (C) of bridging μ²η²-peroxo species per Ti in the H₂O₂-activated catalyst as determined by quantitative ¹⁷O NMR spectroscopy in the range of from 125 to 750 mmol/mol, wherein the concentration (C) of bridging μ²η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min. Further and independently thereof, in the case where providing the catalyst molding in (1) comprises selecting the catalyst, which is comprised in the catalyst molding, among catalysts comprising Ti, Si, and O, wherein the catalyst is selected by calculating an activation factor (A) in accordance with formula I for each of the catalysts, it is preferred that providing the catalyst molding in (1) comprises selecting the catalyst among catalysts displaying a water adsorption in the range of from 1 to 7.9 wt.-%, more preferably from 3 to 7.5 wt.-%, more preferably from 4 to 7 wt.-%, more preferably from 4.5 to 6.5 wt.-%. Alternatively, it is particularly preferred that providing the catalyst molding in (1) comprises selecting the catalyst, which is comprised in the catalyst molding, among catalysts displaying a water adsorption in the range of from 3 to 6.5 wt.-%, more preferably from 3.2 to 4.5 wt.-%, more preferably from 3.4 to 4.1 wt.-%. Further and independently thereof, in the case where providing the catalyst molding in (1) comprises selecting the catalyst, which is comprised in the catalyst molding, among catalysts comprising Ti, Si, and O, wherein the catalyst is selected by calculating an activation factor (A) in accordance with formula I for each of the catalysts, it is preferred that providing the catalyst molding in (1) comprises selecting the catalyst among catalysts displaying a concentration (C) of bridging μ²η²-peroxo species per Ti in the H₂O₂-activated catalyst as determined by quantitative ¹⁷O NMR spectroscopy, preferably determined according to Reference Example 1.3, in the range of from 200 to 725 mmol/mol, preferably from 250 to 700 mmol/mol, more preferably from 300 to 680 mmol/mol, more preferably from 350 to 660 mmol/mol, more preferably from 400 to 640 mmol/mol, more preferably from 450 to 620 mmol/mol, and more preferably from 500 to 600 mmol/mol. Further and independently thereof, in the case where providing the catalyst molding in (1) comprises selecting the catalyst, which is comprised in the catalyst molding, among catalysts comprising Ti, Si, and O, wherein the catalyst is selected by calculating an activation factor (A) in accordance with formula I for each of the catalysts, it is preferred according to the second alternative that T is in the range of from 75 to 165 min after having brought the catalyst into contact with H₂¹⁷O₂, more preferably from 85 min to 155 min after having brought the catalyst into contact with H₂¹⁷O₂, more preferably from 95 to 145 min after having brought the catalyst into contact with H₂¹⁷O₂, more preferably from 105 to 135 min after having brought the catalyst into contact with H₂¹⁷O₂, more preferably from 112 to 128 min after having brought the catalyst into contact with H₂¹⁷O₂, more preferably from 116 to 124 min after having brought the catalyst into contact with H₂¹⁷O₂, more preferably from 118 to 122 min after having brought the catalyst into contact with H₂¹⁷O₂, and more preferably from 119 to 121 min after having brought the catalyst into contact with H₂¹⁷O₂, wherein more preferably T is 120 min after having brought the catalyst into contact with H₂¹⁷O₂. Further and independently thereof, in the case where providing the catalyst molding in (1) comprises selecting the catalyst, which is comprised in the catalyst molding, among catalysts comprising Ti, Si, and O, wherein the catalyst is selected by calculating an activation factor (A) in accordance with formula I for each of the catalysts, it is preferred that the activation factor (A) is in the range of from 11 to 70 mmol/mol, preferably from 12 to 62 mmol/mol, more preferably in the range of from 13 to 60 mmol/mol, more preferably from 14 to 59 mmol/mol, more preferably from 16 to 54 mmol/mol, more preferably from 18 to 49 mmol/mol, more preferably from 20 to 44 mmol/mol, more preferably from 21 to 39 mmol/mol, more preferably from 22 to 34 mmol/mol, more preferably from 23 to 31 mmol/mol, and more preferably from 24 to 28 mmol/mol.

It is preferred that providing the catalyst molding in (1) comprises selecting the catalyst, which is comprised in the catalyst molding, among catalysts comprising from 0 to 1 weight-%, more preferably from 0 to 0.1 weight-%, more preferably from 0 to 0.01 weight-%, more preferably from 0 to 0.001 weight-%, of B, calculated as the element and based on the total weight of the catalyst, which is comprised in the catalyst molding.

It is preferred that providing the catalyst molding in (1) comprises selecting the catalyst, which is comprised in the catalyst molding, among catalysts comprising from 0 to 0.1 weight-%, more preferably from 0 to 0.08 weight-%, of Na, calculated as the element and based on the total weight of the catalyst, which is comprised in the catalyst molding.

It is preferred that providing the catalyst molding in (1) comprises selecting the catalyst, which is comprised in the catalyst molding, among catalysts comprising from 0 to 1 weight-%, more preferably from 0 to 0.1 weight-%, more preferably from 0 to 0.01 weight-%, more preferably from 0 to 0.001 weight-%, of Ge, calculated as the element and based on the total weight of the catalyst, which is comprised in the catalyst molding.

It is preferred that providing the catalyst molding in (1) comprises selecting the catalyst, which is comprised in the catalyst molding, among catalysts comprising from 0 to 1 weight-%, preferably from 0 to 0.5 weight-%, more preferably from 0 to 0.2 weight-%, more preferably from 0 to 0.1 weight-%, more preferably from 0 to 0.01 weight-%, more preferably from 0 to 0.009 weight-%, more preferably from 0 to 0.005 weight-%, more preferably from 0 to 0.001 weight-%, of C, calculated as the element and based on the total weight of the catalyst, which is comprised in the catalyst molding.

It is preferred that providing the catalyst molding in (1) comprises selecting the catalyst, which is comprised in the catalyst molding, among catalysts comprising a content of one or more of Fe, Co, Ni, and Cu, calculated as Fe₂O₃, Co₂O₃, NiO, and CuO, respectively, in the range of from 0 to 0.1 weight-%, more preferably in the range of from 0 to 0.07 weight-%, more preferably in the range of from 0 to 0.05 weight-%, more preferably in the range of from 0 to 0.02 weight-%, based on the weight of the catalyst which is comprised in the catalyst molding. Alternatively, it is preferred that providing the catalyst molding in (1) comprises selecting the catalyst, which is comprised in the catalyst molding, among catalysts comprising a content of one or more of Fe, Co, Ni, and Cu, calculated as the element, respectively, in the range of from 0 to 0.1 weight-%, more preferably in the range of from 0 to 0.07 weight-%, more preferably in the range of from 0 to 0.05 weight-%, more preferably in the range of from 0 to 0.02 weight-%, based on the weight of the catalyst which is comprised in the catalyst molding.

It is preferred that providing the catalyst molding in (1) comprises selecting the catalyst, which is comprised in the catalyst molding, among catalysts exhibiting a propylene oxide activity of at least 2.0 weight-%, more preferably in the range of from 3.0 to 15.0 weight-%, more preferably in the range of from 5.0 to 14.0 weight-%, more preferably in the range of from 9.0 to 13.0 weight-%, preferably determined as described in Reference Example 1.6.

It is preferred that in (2) hydrogen peroxide is comprised in a liquid feed stream which is fed into the reactor, wherein the liquid feed stream further comprises one or more unsaturated organic compounds, more preferably with one or more olefins, more preferably with one or more C₂-C₅ alkenes, more preferably with one or more C₂-C₄ alkenes, more preferably with one or more C₂ or C₃ alkenes, more preferably propylene.

In case where in (2) hydrogen peroxide is comprised in a liquid feed stream which is fed into the reactor, wherein the liquid feed stream further comprises one or more unsaturated organic compounds, it is preferred that the liquid feed stream further comprises a solvent system, wherein the solvent system comprises one or more solvents, wherein more preferably the solvent system comprises one or more hydrophilic solvents, the hydrophilic solvents more preferably being selected from the group consisting of polar solvents, more preferably from the group consisting of polar protic solvents, wherein more preferably the solvent system comprises one or more polar protic solvents selected from the group consisting of water, alcohols, and mixtures of two or more thereof, more preferably from the group consisting of water, C₁-C₅ alcohols, C₁ to C₅ ethers, C₁ to C₅ nitriles, and mixtures of two or more thereof, more preferably from the group consisting of water, C₁-C₄ alcohols, C₁ to C₅ ethers, C₁ to C₄ nitriles, and mixtures of two or more thereof, more preferably from the group consisting of water, C₁-C₄ alcohols, C₁ to C₅ ethers, C₁ to C₃ nitriles, and mixtures of two or more thereof, more preferably from the group consisting of water, methanol, ethanol, propanol, tert-butanol, methyl tert-butyl ether (MTBE), acetonitrile, and mixtures of two or more thereof, more preferably from the group consisting of water, methanol, and mixtures thereof, wherein more preferably the solvent system comprises water, preferably water and methanol, wherein more preferably the solvent system consists of water and methanol.

It is preferred that the liquid feed stream further comprises a potassium-containing compound, preferably a potassium salt, more preferably one or more of dipotassium hydrogen phosphate and a potassium salt of etidronic acid.

Furthermore, and independently thereof, it is preferred that the liquid feed stream comprises hydrogen peroxide at a concentration in the range of from 1 to 75 weight-%, more preferably from 3 to 50 weight-%, 5 to 30 weight-%, more preferably from 7 to 25 weight-%, more preferably from 8 to 20 weight-%, more preferably from 9 to 15 weight-%, more preferably from 10 to 12 weight-%, based on the total weight of the liquid feed stream.

Furthermore, and independently thereof, it is preferred that the liquid feed stream fed into the reactor in (2) has a temperature in the range of from 0 to 60 °C, more preferably from 25 to 50 °C.

Furthermore, and independently thereof, it is preferred that the liquid feed stream fed into the reactor in (2) is at a pressure in the range of from 5 to 100 bar, more preferably from 10 to 50 bar, more preferably from 15 to 25 bar.

Furthermore, and independently thereof, it is preferred that contacting in (2) is conducted at a temperature in the range of from 10 to 100 °C, more preferably from 25 to 80 °C, more preferably from 30 to 75 °C, more preferably from 32 to 65 °C.

Furthermore, and independently thereof, it is preferred that contacting in (2) is conducted at a pressure in the range of from 5 to 100 bar, more preferably from 10 to 50 bar, more preferably from 14 to 32 bar, more preferably from 15 to 25 bar, wherein the pressure is defined as the pressure at the exit of the reactor.

Furthermore, and independently thereof, it is preferred that the catalyst molding loading in the reactor in (1) is in the range of from 0.05 to 5 h⁻¹, preferably from 0.1 to 3 h⁻¹, more preferably from 0.2 to 1 h⁻¹, more preferably from 0.200 to 0.5 h⁻¹, more preferably from 0.210 to 0.25 h⁻¹, more preferably from 0.215 to 0.240 h⁻¹, more preferably from 0.220 to 0.235 h⁻¹, more preferably from 0.225 to 0.230 h⁻¹, wherein the catalyst molding loading is defined as the ratio of the mass flow rate in kg/h of hydrogen peroxide contained in the liquid feed stream divided by the amount in kg of the catalyst molding comprised in the reactor in (1).

Furthermore, and independently thereof, it is preferred that the process further comprises (3) removing an effluent stream from the reactor, the effluent stream comprising an oxidized organic compound, and preferably comprising an epoxidized organic compound, more preferably an alkylene oxide, more preferably an alkylene oxide selected from C₂-C₅ alkylene oxides, more preferably from C₂-C₄ alkylene oxides, more preferably from C₂ or C₃ alkylene oxides, more preferably from C₃ alkylene oxides, wherein more preferably the effluent stream comprises propylene oxide.

The present invention also relates to the use of the catalyst molding according to any one of the particular and preferred embodiments of the present invention as a catalyst and/or catalyst component in a reaction involving one or more of C—O bond formation, C—C bond formation and C—C bond conversion, and preferably as a catalyst and/or catalyst component in an isomerization reaction, in an ammoximation reaction, in an amination reaction, in a hydrocracking reaction, in an alkylation reaction, in an acylation reaction, in a reaction for the conversion of alkanes to olefins, or in a reaction for the conversion of one or more oxygenates to olefins and/or aromatics, in a reaction for the synthesis of hydrogen peroxide, in an aldol condensation reaction, in a reaction for the isomerization of epoxides, in a transesterification reaction, in a hydroxylation reaction, in a Baeyer-Villiger-type oxidation reaction, in a Dakin-type reaction, or in an epoxidation reaction, preferably as a catalyst and/or catalyst component in a hydroxylation reaction, in a Baeyer-Villiger-type oxidation reaction, in a Dakin-type reaction, or in a reaction for the epoxidation of olefins, more preferably in a reaction for the epoxidation of olefins, more preferably in a reaction for the epoxidation of C₂-C₅ alkenes, more preferably in a reaction for the epoxidation of C₂-C₄ alkenes, in a reaction for the epoxidation of C₂ or C₃ alkenes, more preferably for the epoxidation of C₃ alkenes, and more preferably as a catalyst or catalyst component for the conversion of propylene to propylene oxide.

The present invention also relates to a process for preparing an olefin oxide comprising
(A) providing olefin, hydrogen peroxide, water and organic solvent and optionally an additive into an epoxidation zone comprising the catalyst molding according to any one of the particular and preferred embodiments disclosed herein, as a catalyst and/or catalyst component, obtaining a reaction mixture comprising olefin, hydrogen peroxide, water and organic solvent;
(B) subjecting the reaction mixture obtained from (A) to epoxidation reaction conditions in the epoxidation zone, thereby obtaining a mixture comprising olefin oxide, water and organic solvent;
(C) removing an effluent stream from the epoxidation zone, comprising olefin oxide, water and organic solvent.

It is preferred that the olefin is a C₂-C₁₀ alkene, more preferably a C₂-C₅ alkene, more preferably a C₂-C₄ alkene, more preferably ethylene or propylene, more preferably propylene.

Further and independently thereof, it is preferred that the organic solvent is an organic epoxidation solvent, wherein more preferably the organic solvent is selected from the group consisting of C₁ to C₅ mono alcohol, C₁ to C₅ ether, C₁ to C₅ nitrile, and mixtures of two or more thereof, more preferably from the group consisting of tert-butanol, methanol, acetonitrile, methyl tert-butyl ether (MTBE), and mixtures of two or more thereof.

Further and independently thereof, it is preferred that the reaction mixture obtained in (A) comprises the additive, wherein the additive is more preferably selected from the group consisting of potassium salt of an inorganic acid, potassium salt of an organic acid, ammonia, ammonium salt of an inorganic acid, ammonium salt of an organic acid and mixtures of two or more thereof; wherein the additive more preferably comprises a potassium-containing compound, preferably a potassium salt, more preferably one or more of dipotassium hydrogen phosphate and a potassium salt of etidronic acid. According to preferred embodiments of the invention, the additive is provided in (A) as an aqueous solution, wherein the aqueous solution may further comprise the hydrogen peroxide.

The present invention is further illustrated by the following set of embodiments and combinations of embodiments resulting from the dependencies and back-references as indicated. In particular, it is noted that in each instance where a range of embodiments is mentioned, for example in the context of a term such as “The catalyst molding of any one of embodiments 1 to 4”, every embodiment in this range is meant to be explicitly disclosed for the skilled person, i.e. the wording of this term is to be understood by the skilled person as being synonymous to “The catalyst molding of any one of embodiments 1, 2, 3, and 4”. Further, it is explicitly noted that the following set of embodiments is not the set of claims determining the extent of protection but represents a suitably structured part of the description directed to general and preferred aspects of the present invention. Further, it was found that a process for the preparation of such an improved catalyst can be provided. In addition, it was found that a process for the activation of hydrogen peroxide can be provided, wherein a specific catalyst is used.
1. A catalyst molding for hydrogen peroxide activation, wherein the catalyst molding comprises a catalyst for hydrogen peroxide activation, said catalyst comprising Ti, Si, and O, wherein the catalyst comprised in the catalyst molding displays a water adsorption (W), preferably determined according to Reference Example 1.1, a concentration (C) of bridging μ²η²-peroxo species per Ti in the H₂O₂-activated catalyst as determined by quantitative ¹⁷O NMR spectroscopy, preferably determined according to Reference Example 1.3, and an activation factor (A) according to formula I, wherein the activation factor is in the range of from 10 to 75 mmol/mol;
   wherein in accordance with formula I, the activation factor is the multiplication product of the water adsorption and the concentration of bridging μ²η²-peroxo species per Ti in the H₂O₂-activated catalyst:

A=W×C (I).
2. The catalyst molding of embodiment 1, wherein the catalyst molding further comprises one or more oxidic binders, wherein the one or more oxidic binders are preferably selected from the group consisting of inorganic binders, wherein the one or more binders more preferably comprise one or more sources of a metal oxide and/or of a metalloid oxide, more preferably one or more sources of a metal oxide and/or of a metalloid oxide selected from the group consisting of silica, alumina, titania, zirconia, lanthana, magnesia, and mixtures and/or mixed oxides of two or more thereof, more preferably from the group consisting of silica, alumina, titania, zirconia, magnesia, silica-alumina mixed oxides, silica-titania mixed oxides, silica-zirconia mixed oxides, silica-lanthana mixed oxides, silica-zirconia-lanthana mixed oxides, alumina-titania mixed oxides, alumina-zirconia mixed oxides, alumina-lanthana mixed oxides, alumina-zirconia-lanthana mixed oxides, titania-zirconia mixed oxides, and mixtures and/or mixed oxides of two or more thereof, more preferably from the group consisting of silica, alumina, silica-alumina mixed oxides, and mixtures of two or more thereof, wherein more preferably the one or more oxidic binders comprise one or more sources of silica, wherein more preferably the one or more binders consist of one or more sources of silica.
3. The catalyst molding of embodiment 2, wherein the catalyst molding comprises the one or more oxidic binders, calculated as the oxide, in an amount in the range of from 1 to 90 wt.-%, preferably of from 5 to 70 weight-%, more preferably of from 10 to 50 weight-%, more preferably of from 15 to 30 weight-%, more preferably of from 16 to 28 weight-%, more preferably of from 16 to 26 weight-%, more preferably of from 20 to 25 weight-%, based on the weight of the catalyst molding.
4. The catalyst molding of embodiment 2 or 3, wherein from 95 to 100 weight-%, more preferably from 98 to 100 weight-%, more preferably from 99 to 100 weight-%, more preferably from 99.5 to 100 weight-%, more preferably from 99.9 to 100 weight-% of the catalyst molding consist of the catalyst and the one or more oxidic binders.
5. The catalyst molding of any one of embodiments 1 to 4, wherein the catalyst molding exhibits a water adsorption in the range of from 1 to 15 wt.-%, preferably of from 2 to 14 wt.-%, more preferably of from 2.5 to 11 wt.-%, more preferably of from 3 to 10 wt.-%, more preferably of from 4 to 9 wt.-%, more preferably of from 4.4 to 9 wt.-%, more preferably of from 4.4 to 8 wt.-%, more preferably of from 5 to 8 wt.-%, wherein the water adsorption is preferably determined when exposing the catalyst molding to a relative humidity of 85%, wherein the water adsorption is more preferably determined according to Reference Example 1.1.
6. The catalyst molding of embodiment 5, wherein the catalyst molding exhibits a water adsorption in the range of from 3 to 6.5 wt.-%, preferably of form 3.5 to 6 wt.-%, more preferably of from 4.4 to 5.5 wt.-%.
7. The catalyst molding of any one of embodiments 1 to 6, displaying a water adsorption (W), preferably determined according to Reference Example 1.1, a concentration (C) of bridging μ²η²-peroxo species per Ti in the H₂O₂-activated catalyst molding, as determined by quantitative ¹⁷O NMR spectroscopy, preferably determined according to Reference Example 1.3, and an activation factor (A) according to formula I, wherein the activation factor is in the range of from 10 to 75 mmol/mol;
   wherein in accordance with formula I, the activation factor is the multiplication product of the water adsorption and the concentration of bridging μ²η²-peroxo species per Ti in the H₂O₂-activated catalyst molding:

A=W×C (I).
8. The catalyst molding of embodiment 7, displaying a concentration of bridging μ²η²-peroxo species per Ti in the H₂O₂-activated catalyst molding in the range of from 100 to 1,000 mmol/mol, preferably from 200 to 900 mmol/mol, more preferably from 300 to 800 mmol/mol, more preferably from 350 to 700 mmol/mol, more preferably from 400 to 600 mmol/mol, more preferably from 420 to 550 mmol/mol.
9. The catalyst molding of embodiment 7 or 8, wherein the concentration (C) of bridging 2 η²-peroxo species per Ti in the H₂O₂-activated catalyst molding as determined by quantitative ¹⁷O NMR spectroscopy is the concentration which is determined at a time point T after having brought the catalyst molding into contact with H₂¹⁷O₂, wherein T is in the range of from 1 to 720 min after having brought the catalyst molding into contact with H₂¹⁷O₂, preferably from 2 min to 480 min after having brought the catalyst molding into contact with H₂¹⁷O₂, more preferably from 4 to 240 min after having brought the catalyst molding into contact with H₂¹⁷O₂, more preferably from 6 to 120 min after having brought the catalyst molding into contact with H₂¹⁷O₂, more preferably from 8 to 60 min after having brought the catalyst molding into contact with H₂¹⁷O₂, more preferably from 10 to 30 min after having brought the catalyst molding into contact with H₂¹⁷O₂, more preferably from 12 to 20 min after having brought the catalyst molding into contact with H₂¹⁷O₂, and more preferably from 14 to 16 min after having brought the catalyst molding into contact with H₂¹⁷O₂, wherein more preferably T is 15 min after having brought the catalyst molding into contact with H₂¹⁷O₂.
10. The catalyst molding of any one of embodiments 7 to 9, wherein the activation factor of the catalyst molding is in the range of from 12 to 70 mmol/mol, preferably from 14 to 65 mmol/mol, more preferably from 16 to 60 mmol/mol, more preferably from 17 to 55 mmol/mol, more preferably from 18 to 50 mmol/mol, more preferably from 19 to 44 mmol/mol, more preferably from 20 to 39 mmol/mol, more preferably from 21 to 34 mmol/mol, more preferably from 22 to 29 mmol/mol, and more preferably from 23 to 26 mmol/mol.
11. The catalyst molding of embodiment 7, displaying a concentration of bridging μ²η²-peroxo species per Ti in the H₂O₂-activated catalyst molding in the range of from 100 to 1,000 mmol/mol, wherein the concentration of bridging μ²η²-peroxo species per Ti in the H₂O₂-activated catalyst molding as determined by quantitative ¹⁷O NMR spectroscopy is the concentration which is determined at a time point T after having brought the catalyst molding into contact with H₂¹⁷O₂, wherein T is in the range of from 65 to 175 min.
12. The catalyst molding of embodiment 11, displaying a concentration of bridging μ²η²-peroxo species per Ti in the H₂O₂-activated catalyst molding as determined by quantitative ¹⁷O NMR spectroscopy, preferably determined according to Reference Example 1.2, in the range of from 200 to 900 mmol/mol, preferably from 300 to 800 mmol/mol, more preferably from 380 to 750 mmol/mol, more preferably from 420 to 700 mmol/mol, more preferably from 450 to 650 mmol/mol.
13. The catalyst molding of embodiment 11 or 12, wherein T is in the range of from 75 to 165 min after having brought the catalyst molding into contact with H₂¹⁷O₂, preferably from 85 min to 155 min after having brought the catalyst molding into contact with H₂¹⁷O₂, more preferably from 95 to 145 min after having brought the catalyst molding into contact with H₂¹⁷O₂, more preferably from 105 to 135 min after having brought the catalyst molding into contact with H₂¹⁷O₂, more preferably from 112 to 128 min after having brought the catalyst molding into contact with H₂¹⁷O₂, more preferably from 116 to 124 min after having brought the catalyst molding into contact with H₂¹⁷O₂, more preferably from 118 to 122 min after having brought the catalyst molding into contact with H₂¹⁷O₂, and more preferably from 119 to 121 min after having brought the catalyst molding into contact with H₂¹⁷O₂, wherein more preferably T is 120 min after having brought the catalyst molding into contact with H₂¹⁷O₂.
14. The catalyst molding of any one of embodiments 11 to 13, wherein the activation factor of the catalyst molding is in the range of from 12 to 70 mmol/mol, preferably from 14 to 65 mmol/mol, more preferably from 16 to 60 mmol/mol, more preferably from 18 to 55 mmol/mol, more preferably from 19 to 50 mmol/mol, more preferably from 20 to 45 mmol/mol, more preferably from 21 to 40 mmol/mol, more preferably from 22 to 37 mmol/mol, more preferably from 23 to 35 mmol/mol, and more preferably from 24 to 34 mmol/mol.
15. The catalyst molding of any one of embodiments 1 to 14, wherein the catalyst molding exhibits a BET specific surface area in the range of from 50 to 700 m²/g, preferably of from 100 to 500 m²/g, more preferably of from 150 to 475 m²/g, more preferably of from 200 to 450 m²/g, more preferably of from 250 to 425 m²/g, more preferably of from 300 to 400 m²/g, more preferably of from 320 to 400 m²/g, wherein the BET specific surface area is preferably determined according to Reference Example 1.5.
16. The catalyst molding of any one of embodiments 1 to 15, wherein the catalyst molding exhibits a total pore volume in the range of from 0.2 to 1.5 g/ml, preferably in the range of from 0.4 to 1.4 g/ml, more preferably in the range of from 0.4 to 1.3 g/ml, more preferably in the range of from 0.5 to 1.1 ml/g, more preferably in the range of from 0.7 to 1.0 ml/g, wherein the pore volume is preferably determined according to Reference Example 1.11.
17. The catalyst molding of any one of embodiments 1 to 16, wherein the catalyst molding exhibits an average crush strength in the range of from 3 to 30 N, preferably in the range of from 4 to 25 N, more preferably in the range of from 5 to 20 N, more preferably in the range of from 5 to 15 N, wherein the average crush strength is preferably determined according to Reference Example 1.8.
18. The catalyst molding of any one of embodiments 1 to 17, wherein the catalyst molding has a sodium content, calculated as Na₂O, in the range of from 0 to 0.5 weight-%, preferably of from 0 to 0.2 weight-%, more preferably of from 0 to 0.15 weight-%, more preferably of from 0 to 0.14 weight-%, more preferably in the range of from 0 to 0.1 weight-%, more preferably of less than 0.1 weight-%, more preferably of from 0 to 0.08 weight-%, based on the weight of the catalyst molding.
19. The catalyst molding of any one of embodiments 1 to 18, wherein the catalyst molding exhibits an acid site density in the range of from 1 to 1000 μmol/g, preferably in the range of from 5 to 500 μmol/g, more preferably in the range of from 10 to 100 μmol/g, at a temperature below 250 °C, determined according to Reference Example 1.9.
20. The catalyst molding of any one of embodiments 1 to 19, wherein the catalyst molding exhibits a propylene oxide activity of at least 2.0 weight-%, preferably in the range of from 3.0 to 15.0 weight-%, more preferably in the range of from 3.5 to 10.0 weight-%, more preferably in the range of from 4.0 to 7.5 weight-%, more preferably in the range of from 4.5 to 6.5 weight-%, more preferably in the range of from 5.5 to 6.3 weight-%, preferably determined as described in Reference Example 1.6.
21. The catalyst molding of any one of embodiments 1 to 20, wherein the catalyst molding is in the form of a strand, preferably having a cross-sectional profile, wherein the cross-sectional profile more preferably is hexagonal, rectangular, quadratic, triangular, oval, or circular, more preferably circular, wherein the cross-sectional profile more preferably has a diameter in the range of from 0.1 to 10 mm, more preferably in the range of from 0.2 to 7 mm, more preferably in the range of from 0.5 to 5 mm, more preferably in the range of from 1.0 to 3.0 mm, more preferably in the range of from 1.5 to 2.0 mm.
22. The catalyst molding of embodiment 21, wherein the catalyst molding is an extrudate.
23. The catalyst molding of any one of embodiments 1 to 22, wherein the catalyst comprised in the catalyst molding displays a water adsorption in the range of from 1 to 10 wt.-%, preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%.
24. The catalyst molding of embodiment 23, wherein the catalyst comprised in the catalyst molding displays a water adsorption in the range of from 3 to 6.5 wt.-%, preferably from 3.2 to 4.5 wt.-%, more preferably from 3.4 to 4.1 wt.-%.
25. The catalyst molding of any one of embodiments 1 to 24, wherein the catalyst comprised in the catalyst molding displays a concentration of bridging μ²η²-peroxo species per Ti in the H₂O₂-activated catalyst in the range of from 150 to 1,000 mmol/mol, preferably from 100 to 800 mmol/mol, more preferably from 150 to 750 mmol/mol, more preferably from 200 to 700 mmol/mol, more preferably from 250 to 650 mmol/mol, more preferably from 300 to 600 mmol/mol, more preferably from 350 to 550 mmol/mol, and more preferably from 400 to 500 mmol/mol.
26. The catalyst molding of any one of embodiments 1 to 25, wherein the concentration (C) of bridging μ²η²-peroxo species per Ti in the H₂O₂-activated catalyst as determined by quantitative ¹⁷O NMR spectroscopy is the concentration which is determined at a time point T after having brought the catalyst, which is comprised in the catalyst molding, into contact with H₂¹⁷O₂, wherein T is in the range of from 1 to 720 min after having brought the catalyst into contact with H₂¹⁷O₂, preferably from 2 min to 480 min after having brought the catalyst into contact with H₂¹⁷O₂, more preferably from 4 to 240 min after having brought the catalyst into contact with H₂¹⁷O₂, more preferably from 6 to 120 min after having brought the catalyst into contact with H₂¹⁷O₂, more preferably from 8 to 60 min after having brought the catalyst into contact with H₂¹⁷O₂, more preferably from 10 to 30 min after having brought the catalyst into contact with H₂¹⁷O₂, more preferably from 12 to 20 min after having brought the catalyst into contact with H₂¹⁷O₂, and more preferably from 14 to 16 min after having brought the catalyst into contact with H₂¹⁷O₂, wherein more preferably T is 15 min after having brought the catalyst into contact with H₂¹⁷O₂.
27. The catalyst molding of any one of embodiments 1 to 26, wherein the activation factor of the catalyst comprised in the catalyst molding is in the range of from 11 to 65 mmol/mol, preferably from 13 to 55 mmol/mol, more preferably from 15 to 50 mmol/mol, more preferably from 18 to 45 mmol/mol, more preferably from 20 to 40 mmol/mol, more preferably from 21 to 39 mmol/mol, more preferably from 22 to 37 mmol/mol, more preferably from 23 to 35 mmol/mol, more preferably from 24 to 32 mmol/mol, and more preferably from 25 to 30 mmol/mol.
28. The catalyst molding of any one of embodiments 1 to 27, wherein the catalyst comprised in the catalyst molding displays a concentration of bridging μ²η²-peroxo species per Ti in the H₂O₂-activated catalyst in the range of from 125 to 750 mmol/mol, wherein the concentration of bridging μ²η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min.
29. The catalyst molding of embodiment 28, wherein the catalyst comprised in the catalyst molding displays a water adsorption in the range of from 1 to 7.9 wt.-%, preferably from 3 to 7.5 wt.-%, more preferably from 4 to 7 wt.-%, more preferably from 4.5 to 6.5 wt.-%.
30. The catalyst molding of embodiment 29, wherein the catalyst comprised in the catalyst molding displays a water adsorption in the range of from 3 to 6.5 wt.-%, preferably from 3.2 to 4.5 wt.-%, more preferably from 3.4 to 4.1 wt.-%.
31. The catalyst molding of embodiment 28 to 30, wherein the catalyst comprised in the catalyst molding displays a concentration of bridging μ²η²-peroxo species per Ti in the H₂O₂-activated catalyst as determined by quantitative ¹⁷O NMR spectroscopy, preferably determined according to Reference Example 1.3, in the range of from 200 to 725 mmol/mol, preferably from 250 to 700 mmol/mol, more preferably from 300 to 680 mmol/mol, more preferably from 350 to 660 mmol/mol, more preferably from 400 to 640 mmol/mol, more preferably from 450 to 620 mmol/mol, and more preferably from 500 to 600 mmol/mol.
32. The catalyst molding of any one of embodiments 28 to 31, wherein T is in the range of from 75 to 165 min after having brought the catalyst into contact with H₂¹⁷O₂, preferably from 85 min to 155 min after having brought the catalyst into contact with H₂¹⁷O₂, more preferably from 95 to 145 min after having brought the catalyst into contact with H₂¹⁷O₂, more preferably from 105 to 135 min after having brought the catalyst into contact with H₂¹⁷O₂, more preferably from 112 to 128 min after having brought the catalyst into contact with H₂¹⁷O₂, more preferably from 116 to 124 min after having brought the catalyst into contact with H₂¹⁷O₂, more preferably from 118 to 122 min after having brought the catalyst into contact with H₂¹⁷O₂, and more preferably from 119 to 121 min after having brought the catalyst into contact with H₂¹⁷O₂, wherein more preferably T is 120 min after having brought the catalyst into contact with H₂¹⁷O₂.
33. The catalyst molding of any one of embodiments 28 to 32, wherein the activation factor of the catalyst comprised in the catalyst molding is in the range of from 11 to 70 mmol/mol, preferably from 12 to 62 mmol/mol, more preferably in the range of from 13 to 60 mmol/mol, more preferably from 14 to 59 mmol/mol, more preferably from 16 to 54 mmol/mol, more preferably from 18 to 49 mmol/mol, more preferably from 20 to 44 mmol/mol, more preferably from 21 to 39 mmol/mol, more preferably from 22 to 34 mmol/mol, more preferably from 23 to 31 mmol/mol, and more preferably from 24 to 28 mmol/mol.
34. The catalyst molding of any one of embodiments 1 to 33, wherein the catalyst comprised in the catalyst molding displays a XANES spectrum having a ratio of the intensity of the signal at 4987 eV to the intensity of the signal at 4992 eV in the range of from 0.95:1 to 1.07:1, preferably of from 0.97:1 to 1.07:1, more preferably in the range of from 0.99:1 to 1.07:1, more preferably in the range of from 1.01:1 to 1.07:1, more preferably in the range of from 1.03:1 to 1.07:1, and more preferably in the range of from 1.05:1 to 1.07:1, wherein the XANES spectrum is preferably determined according Reference Example 1.2.
35. The catalyst molding of any one of embodiments 1 to 34, wherein the catalyst comprised in the catalyst molding has a BET specific surface area in the range of from 350 to 475 m²/g, preferably from 370 to 460 m²/g, more preferably from 390 to 445 m²/g, wherein the BET specific surface area is preferably determined according to Reference Example 1.5.
36. The catalyst molding of any one of embodiments 1 to 35, wherein the catalyst comprised in the catalyst molding comprises from 0.2 to 5 weight-%, preferably in the range of from 0.5 to 4 weight-%, more preferably in the range of from 0.7 to 3 weight-%, more preferably of from 0.7 to 2.5 weight-%, preferably from 0.8 to 2.0 weight-%, more preferably from 1.0 to 1.9 weight-%, more preferably from 1.0 to 1.8 weight-%, more preferably from 1.1 to 1.3 weight-%, of Ti, calculated as the element and based on the total weight of the catalyst comprised in the catalyst molding.
37. The catalyst molding of any one of embodiments 1 to 36, wherein the catalyst comprised in the catalyst molding comprises from 0 to 1 weight-%, preferably from 0 to 0.1 weight-%, more preferably from 0 to 0.01 weight-%, more preferably from 0 to 0.001 weight-%, of B, calculated as the element and based on the total weight of the catalyst comprised in the catalyst molding.
38. The catalyst molding of any one of embodiments 1 to 37, wherein the catalyst comprised in the catalyst molding comprises from 0 to 0.1 weight-%, preferably from 0 to 0.08 weight-%, of Na, calculated as the element and based on the total weight of the catalyst comprised in the catalyst molding.
39. The catalyst molding of any one of embodiments 1 to 38, wherein the catalyst comprised in the catalyst molding comprises from 0 to 1 weight-%, preferably from 0 to 0.1 weight-%, more preferably from 0 to 0.01 weight-%, more preferably from 0 to 0.001 weight-%, of Ge, calculated as the element and based on the total weight of the catalyst comprised in the catalyst molding.
40. The catalyst molding of any one of embodiments 1 to 39, wherein the catalyst comprised in the catalyst molding comprises from 0 to 1 weight-%, preferably from 0 to 0.5 weight-%, more preferably from 0 to 0.2 weight-%, more preferably from 0 to 0.1 weight-%, more preferably from 0 to 0.01 weight-%, more preferably from 0 to 0.009 weight-%, more preferably from 0 to 0.005 weight-%, more preferably from 0 to 0.001 weight-%, of C, calculated as the element and based on the total weight of the catalyst comprised in the catalyst molding.
41. The catalyst molding of any one of embodiments 1 to 40, wherein the catalyst comprised in the catalyst molding comprises a content of one or more of Fe, Co, Ni, and Cu, calculated as Fe₂O₃, Co₂O₃, NiO, and CuO, respectively, in the range of from 0 to 0.1 weight-%, preferably in the range of from 0 to 0.07 weight-%, more preferably in the range of from 0 to 0.05 weight-%, more preferably in the range of from 0 to 0.02 weight-%, based on the weight of the catalyst which is comprised in the catalyst molding.
42. The catalyst molding of any one of embodiments 1 to 40, wherein the catalyst comprised in the catalyst molding comprises a content of one or more of Fe, Co, Ni, and Cu, calculated as the element, respectively, in the range of from 0 to 0.1 weight-%, preferably in the range of from 0 to 0.07 weight-%, more preferably in the range of from 0 to 0.05 weight-%, more preferably in the range of from 0 to 0.02 weight-%, based on the weight of the catalyst which is comprised in the catalyst molding.
43. The catalyst molding of any one of embodiments 1 to 42, wherein the catalyst comprised in the catalyst molding exhibits a propylene oxide activity of at least 2.0 weight-%, preferably in the range of from 3.0 to 15.0 weight-%, more preferably in the range of from 5.0 to 14.0 weight-%, more preferably in the range of from 9.0 to 13.0 weight-%, preferably determined as described in Reference Example 1.6.
44. The catalyst molding of any one of embodiments 1 to 43, wherein the catalyst comprised in the catalyst molding further comprises one or more metals selected from the group consisting of K, Zn, Cd, Sn, La, and Ba, including mixtures of two or more thereof, preferably from the group consisting of Zn, Cd, Sn, La, and Ba, including mixtures of two or more thereof.
45. The catalyst molding of any one of embodiments 1 to 44, wherein from 95 to 100 wt.-% of the catalyst comprised in the catalyst molding consists of Ti, Si, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
46. The catalyst molding of any one of embodiments 1 to 45, wherein from 95 to 100 wt.-% of the catalyst comprised in the catalyst molding consists of Ti, Si, O, and H, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
47. The catalyst molding of any one of embodiments 2 to 46, wherein from 95 to 100 weight-%, preferably from 98 to 100 weight-%, more preferably from 99 to 100 weight-%, more preferably from 99.5 to 100 weight-%, more preferably from 99.9 to 100 weight-% of the one or more oxidic binders comprised in the catalyst molding consist of Si and O.
48. The catalyst molding of any one of embodiments 1 to 47, wherein the catalyst comprised in the catalyst molding comprises, preferably consists of, a zeolitic material having a framework structure comprising Si, Ti, and O.
49. The catalyst molding of embodiment 48, wherein the zeolitic material has an Si: Ti molar ratio in the range of from 1 to 250, preferably in the range of from 10 to 150, more preferably in the range of from 20 to 95, more preferably in the range of from 30 to 75, more preferably in the range of from 35 to 70, more preferably in the range of from 40 to 65, more preferably in the range of from 45 to 60, more preferably in the range of from 50 to 55.
50. The catalyst molding of embodiment 48 or 49, wherein the zeolitic material has a framework structure type selected from the group consisting of MFI, MEL, MWW, ITH, IWR, IMF, SVY, FER, SVR, and intergrowth structures of two or more thereof, preferably selected from the group consisting of MFI, MEL, MWW, ITH, and IWR, and intergrowth structures of two or more thereof, more preferably selected from the group consisting of MFI, MEL, and intergrowth structures thereof, wherein the zeolitic material more preferably has an MFI-type framework structure.
51. The catalyst molding of any one of embodiments 48 to 50, wherein the zeolitic material is a TS-1 zeolite.
52. The catalyst molding of any one of embodiments 48 to 51, wherein the zeolitic material further comprises one or more metals selected from the group consisting of K, Zn, Cd, Sn, La, and Ba, including mixtures of two or more thereof, preferably from the group consisting of Zn, Cd, Sn, La, and Ba, including mixtures of two or more thereof, wherein the one or more metals are preferably contained in the pores of the zeolitic material.
53. The catalyst molding of any one of embodiments 48 to 52, wherein from 95 to 100 wt.-% of the zeolitic material consists of Ti, Si, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
54. The catalyst molding of any one of embodiments 48 to 53, wherein from 95 to 100 wt.-% of the zeolitic material consists of Ti, Si, O, and H, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
55. The catalyst molding of any one of embodiments 48 to 54, wherein the zeolitic material has a crystallinity in the range of from 50 to 110 weight-%, preferably from 50 to 100 weight-%, more preferably from 75 to 100 weight-%, more preferably from 80 to 100 weight-%, and more preferably from 90 to 100 weight-%, wherein the crystallinity is preferably determined as described in Reference Example 1.4.
56. A method for preparing a catalyst molding, preferably for preparing a catalyst molding according to any one of embodiments 1 to 55, comprising
   (a) providing a catalyst for hydrogen peroxide activation, as defined in any one of embodiments 1 and 21 to 55;
   (b) mixing the catalyst provided in step (a) with one or more binders;
   (c) optionally kneading of the mixture obtained in step (b);
   (d) molding of the mixture obtained in step (b) or (c) to obtain a precursor of the catalyst molding;
   (e) optionally preparing a mixture comprising the precursor of the catalyst molding obtained from (d) and water, and subjecting the mixture to a water treatment under hydrothermal conditions, obtaining a water-treated precursor of the catalyst molding;
   (f) optionally drying of the precursor of the catalyst molding obtained from (d) or of the water-treated precursor of the catalyst molding obtained in (e); and
   (g) calcining of the one or more catalyst moldings obtained in step (d), (e) or (f).
57. The method of embodiment 56, wherein providing the catalyst in (a) comprises selecting the catalyst, which is comprised in the catalyst molding, among catalysts comprisesing Ti, Si, and O, and displaying
   a water adsorption (W), preferably determined according to Reference Example 1.1, and
   a concentration (C) of bridging μ²η²-peroxo species per Ti in the H₂O₂-activated catalyst as determined by quantitative ¹⁷O NMR spectroscopy, preferably according to Reference Example 1.3;
   wherein the catalyst is selected by calculating an activation factor (A) in accordance with formula I for each of the catalysts, and selecting a catalyst displaying an activation factor in the range of from 10 to 75 mmol/mol, wherein the activation factor is the multiplication product of the water adsorption and the concentration of bridging μ²η²-peroxo species per Ti in the H₂O₂-activated catalyst:

A=W×C (I).
58. The method of embodiment 56 or 57, wherein providing the catalyst in (a) comprises selecting the catalyst, which is comprised in the catalyst molding, among catalysts displaying a water adsorption in the range of from 1 to 10 wt.-%, more preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%.
59. The method of embodiment 58, wherein providing the catalyst in (a) comprises selecting the catalyst, which is comprised in the catalyst molding, among catalysts displaying a water adsorption in the range of from 3 to 6.5 wt.-%, preferably from 3.2 to 4.5 wt.-%, more preferably from 3.4 to 4.1 wt.-%.
60. The method of any one of embodiments 56 to 59, wherein providing the catalyst in (a) comprises selecting the catalyst, which is comprised in the catalyst molding, among catalysts displaying a concentration of bridging μ²η²-peroxo species per Ti in the H₂O₂-activated catalyst in the range of from 150 to 1,000 mmol/mol, more preferably from 100 to 800 mmol/mol, more preferably from 150 to 750 mmol/mol, more preferably from 200 to 700 mmol/mol, more preferably from 250 to 650 mmol/mol, more preferably from 300 to 600 mmol/mol, more preferably from 350 to 550 mmol/mol, and more preferably from 400 to 500 mmol/mol.
61. The method of any one of embodiments 56 to 60, wherein the catalyst, which is comprised in the catalyst molding, is selected by calculating an activation factor (A) for each of the catalysts, and selecting a catalyst displaying an activation factor in the range of from 11 to 65 mmol/mol, more preferably from 13 to 55 mmol/mol, more preferably from 15 to 50 mmol/mol, more preferably from 18 to 45 mmol/mol, more preferably from 20 to 40 mmol/mol, more preferably from 21 to 39 mmol/mol, more preferably from 22 to 37 mmol/mol, more preferably from 23 to 35 mmol/mol, more preferably from 24 to 32 mmol/mol, and more preferably from 25 to 30 mmol/mol.
62. The method of any one of embodiments 56 to 61, wherein the concentration (C) of bridging μ²η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 1 to 720 min after having brought the catalyst, which is comprised in the catalyst molding, into contact with H₂¹⁷O₂, more preferably from 2 min to 480 min after having brought the catalyst into contact with H₂¹⁷O₂, more preferably from 4 to 240 min after having brought the catalyst into contact with H₂¹⁷O₂, more preferably from 6 to 120 min after having brought the catalyst into contact with H₂¹⁷O₂, more preferably from 8 to 60 min after having brought the catalyst into contact with H₂¹⁷O₂, more preferably from 10 to 30 min after having brought the catalyst into contact with H₂¹⁷O₂, more preferably from 12 to 20 min after having brought the catalyst into contact with H₂¹⁷O₂, and more preferably from 14 to 16 min after having brought the catalyst into contact with H₂¹⁷O₂, wherein more preferably T is 15 min after having brought the catalyst into contact with H₂¹⁷O₂.
63. The method of embodiment 62, wherein providing the catalyst in (a) comprises selecting the catalyst, which is comprised in the catalyst molding, among catalysts displaying a concentration (C) of bridging μ²η²-peroxo species per Ti in the H₂O₂-activated catalyst as determined by quantitative ¹⁷O NMR spectroscopy in the range of from 125 to 750 mmol/mol, wherein the concentration (C) of bridging μ²η²-peroxo species per Ti in the H₂O₂-activated catalyst as determined by quantitative ¹⁷O NMR spectroscopy is the concentration which is determined at a time point T after having brought the catalyst into contact with H₂¹⁷O₂, wherein T is in the range of from 65 to 175 min.
64. The method of embodiment 63, wherein providing the catalyst in (a) comprises selecting the catalyst, which is comprised in the catalyst molding, among catalysts displaying a water adsorption in the range of from 1 to 7.9 wt.-%, preferably from 3 to 7.5 wt.-%, more preferably from 4 to 7 wt.-%, more preferably from 4.5 to 6.5 wt.-%.
65. The method of embodiment 64, wherein providing the catalyst in (a) comprises selecting the catalyst, which is comprised in the catalyst molding, among catalysts displaying a water adsorption in the range of from 3 to 6.5 wt.-%, preferably from 3.2 to 4.5 wt.-%, more preferably from 3.4 to 4.1 wt.-%.
66. The method of embodiments 63 to 65, wherein providing the catalyst in (a) comprises selecting the catalyst, which is comprised in the catalyst molding, among catalysts displaying a concentration (C) of bridging μ²η²-peroxo species per Ti in the H₂O₂-activated catalyst as determined by quantitative ¹⁷O NMR spectroscopy, preferably determined according to Reference Example 1.3, in the range of from 200 to 725 mmol/mol, preferably from 250 to 700 mmol/mol, more preferably from 300 to 680 mmol/mol, more preferably from 350 to 660 mmol/mol, more preferably from 400 to 640 mmol/mol, more preferably from 450 to 620 mmol/mol, and more preferably from 500 to 600 mmol/mol.
67 The method of any one of embodiments 63 to 66, wherein T is in the range of from 75 to 165 min after having brought the catalyst into contact with H₂¹⁷O₂, preferably from 85 min to 155 min after having brought the catalyst into contact with H₂¹⁷O₂, more preferably from 95 to 145 min after having brought the catalyst into contact with H₂¹⁷O₂, more preferably from 105 to 135 min after having brought the catalyst into contact with H₂¹⁷O₂, more preferably from 112 to 128 min after having brought the catalyst into contact with H₂¹⁷O₂, more preferably from 116 to 124 min after having brought the catalyst into contact with H₂¹⁷O₂, more preferably from 118 to 122 min after having brought the catalyst into contact with H₂¹⁷O₂, and more preferably from 119 to 121 min after having brought the catalyst into contact with H₂¹⁷O₂, wherein more preferably T is 120 min after having brought the catalyst into contact with H₂¹⁷O₂.
68. The method of any one of embodiments 63 to 67, wherein the activation factor (A) is in the range of from 11 to 70 mmol/mol, preferably from 12 to 62 mmol/mol, more preferably in the range of from 13 to 60 mmol/mol, more preferably from 14 to 59 mmol/mol, more preferably from 16 to 54 mmol/mol, more preferably from 18 to 49 mmol/mol, more preferably from 20 to 44 mmol/mol, more preferably from 21 to 39 mmol/mol, more preferably from 22 to 34 mmol/mol, more preferably from 23 to 31 mmol/mol, and more preferably from 24 to 28 mmol/mol.
69. The method of any one of embodiments 56 to 68, wherein providing the catalyst in (a) comprises selecting the catalyst, which is comprised in the catalyst molding, among catalysts comprising from 0 to 1 weight-%, preferably from 0 to 0.1 weight-%, more preferably from 0 to 0.01 weight-%, more preferably from 0 to 0.001 weight-%, of B, calculated as the element and based on the total weight of the catalyst.
70. The method of any one of embodiments 56 to 69, wherein providing the catalyst in (a) comprises selecting the catalyst, which is comprised in the catalyst molding, among catalysts comprising from 0.1 weight-%, preferably from 0 to 0.08 weight-%, of Na, calculated as the element and based on the total weight of the catalyst.
71. The method of any one of embodiments 56 to 70, wherein providing the catalyst in (a) comprises selecting the catalyst, which is comprised in the catalyst molding, among catalysts comprising from 0 to 1 weight-%, preferably from 0 to 0.1 weight-%, more preferably from 0 to 0.01 weight-%, more preferably from 0 to 0.001 weight-%, of Ge, calculated as the element and based on the total weight of the catalyst.
72. The method of any one of embodiments 56 to 71, wherein providing the catalyst in (a) comprises selecting the catalyst, which is comprised in the catalyst molding, among catalysts comprising from 0 to 1 weight-%, preferably from 0 to 0.5 weight-%, more preferably from 0 to 0.2 weight-%, more preferably from 0 to 0.1 weight-%, more preferably from 0 to 0.01 weight-%, more preferably from 0 to 0.009 weight-%, more preferably from 0 to 0.005 weight-%, more preferably from 0 to 0.001 weight-%, of C, calculated as the element and based on the total weight of the catalyst.
73. The method of any one of embodiments 56 to 62, wherein providing the catalyst in (a) comprises selecting the catalyst, which is comprised in the catalyst molding, among catalysts exhibiting a propylene oxide activity of at least 2.0 weight-%, preferably in the range of from 3.0 to 15.0 weight-%, more preferably in the range of from 5.0 to 14.0 weight-%, more preferably in the range of from 9.0 to 13.0 weight-%, preferably determined as described in Reference Example 1.6.
74. The method of any one of embodiments 56 to 73, wherein the one or more binders in (b) are selected from the group consisting of inorganic binders, wherein the one or more binders preferably comprise one or more sources of a metal oxide and/or of a metalloid oxide, more preferably one or more sources of a metal oxide and/or of a metalloid oxide selected from the group consisting of silica, alumina, titania, zirconia, lanthana, magnesia, and mixtures and/or mixed oxides of two or more thereof, more preferably from the group consisting of silica, alumina, titania, zirconia, magnesia, silica-alumina mixed oxides, silica-titania mixed oxides, silica-zirconia mixed oxides, silica-lanthana mixed oxides, silica-zirconia-lanthana mixed oxides, alumina-titania mixed oxides, alumina-zirconia mixed oxides, alumina-lanthana mixed oxides, alumina-zirconia-lanthana mixed oxides, titania-zirconia mixed oxides, and mixtures and/or mixed oxides of two or more thereof, more preferably from the group consisting of silica, alumina, silica-alumina mixed oxides, and mixtures of two or more thereof, wherein more preferably the one or more binders in (b) comprise one or more sources of silica, wherein more preferably the one or more binders in (b) consist of one or more sources of silica, wherein the one or more sources of silica preferably comprise one or more compounds selected from the group consisting of fumed silica, colloidal silica, silica-alumina, colloidal silica-alumina, and mixtures of two or more thereof, more preferably one or more compounds selected from the group consisting of fumed silica, colloidal silica, and mixtures thereof, wherein more preferably the one or more binders in (b) consist of colloidal silica.
75. The method of any one of embodiments 56 to 74, wherein step (b) further comprises mixing the zeolitic material and the one or more binders with a solvent system, wherein the solvent system comprises one or more solvents, wherein preferably the solvent system comprises one or more hydrophilic solvents, the hydrophilic solvents preferably being selected from the group consisting of polar solvents, more preferably from the group consisting of polar protic solvents, wherein more preferably the solvent system comprises one or more polar protic solvents selected from the group consisting of water, alcohols, carboxylic acids, and mixtures of two or more thereof, more preferably from the group consisting of water, C₁-C₅ alcohols, C₁-C₅ carboxylic acids, and mixtures of two or more thereof, more preferably from the group consisting of water, C₁-C₄ alcohols, C₁-C₄ carboxylic acids, and mixtures of two or more thereof, more preferably from the group consisting of water, C₁-C₃ alcohols, C₁-C₃ carboxylic acids, and mixtures of two or more thereof, more preferably from the group consisting of water, methanol, ethanol, propanol, formic acid, acetic acid, and mixtures of two or more thereof, more preferably from the group consisting of water, ethanol, acetic acid, and mixtures of two or more thereof, wherein more preferably the solvent system comprises water and/or ethanol, and wherein more preferably the solvent system comprises water, wherein even more preferably the solvent system consists of water.
76. The method of any one of embodiments 56 to 75, wherein step (b) further comprises mixing the zeolitic material and the one or more binders with one or more agents, preferably with one or more pore forming agents and/or lubricants and/or plasticizers, wherein the one or more agents comprise, preferably consist of, one or more of water, alcohols, organic polymers, carbohydrates, graphite, plant additives, and mixtures of two or more thereof, preferably one or more of water, alcohols, organic polymers, polysaccharides, carbohydrates, graphite, plant additives, and mixtures of two or more thereof, more preferably one or more of water, polymeric vinyl compounds, celluloses, cellulose derivatives, polymannoses, polymannose derivatives, starches, polyalkylene oxides, polystyrenes, polyacrylates, polymethacrylates, polyolefins, polyamides, polyesters, and mixtures of two or more thereof, more preferably one or more of water, polymeric vinyl compounds, polyalkylene oxides, polyacrylates, polyolefins, polystyrenes, polyamides, polyesters, celluloses, cellulose derivatives, polymannoses, polymannose derivatives, and mixtures of two or more thereof, more preferably one or more of water, polystyrene, C₂-C₃ polyalkylene oxides, polymeric vinyl compounds, cellulose, hydroxymethylcellulose, methoxy cellulose, ethoxy cellulose, polymannose at least partially derivatized with galactose, and mixtures of two or more thereof, more preferably one or more of water, polystyrene, polyethylene oxide, a polyvinyl acetate, hydroxymethylcellulose, methoxy cellulose, ethoxy cellulose, a cellulose, a galactomannan, and mixtures of two or more thereof, wherein the one or more agents more preferably comprise, more preferably consist of, one or more of water, polystyrene, polyethylene oxide, hydroxymethylcellulose, methoxy cellulose, ethoxy cellulose, and mixtures of two or more thereof.
77. The method of any one of embodiments 56 to 76, further comprising after (d) and prior to (e) drying the precursor of the catalyst molding obtained from (d), obtaining a dried precursor of the catalyst molding, wherein the method preferably further comprises calcining the dried precursor of the catalyst molding, wherein calcining is preferably performed at a temperature ranging from 350 to 850 °C, more preferably from 400 to 700 °C, more preferably from 450 to 650 °C, and more preferably from 475 to 600 °C.
78. The method of any one of embodiments 56 to 77, wherein the water treatment according to (e) is performed with a water containing solvent system and/or with an aqueous solution, wherein preferably the hydrothermal treatment is performed with deionized water.
79. The method of any one of embodiments 56 to 78, wherein the water treatment according to (e) comprises a temperature of the mixture in the range of from 130 to 160 °C, preferably in the range of from 140 to 150 °C.
80. The method of any one of embodiments 56 to 79, wherein the water treatment according to (e) is carried out under autogenous pressure, preferably in an autoclave.
81. The method of any one of embodiments 56 to 80, wherein the water treatment according to (e) is carried out for 6 to 15 h, preferably for 7 to 10 h.
82. The method of any one of embodiments 56 to 81, wherein in the mixture prepared in (e), the weight ratio of the precursor of the catalyst molding obtained from (d) relative to the water is in the range of from 1:25 to 1:10, preferably in the range of from 1:21 to 1:14.
83. The method of any one of embodiments 56 to 82, wherein after (d) and prior to (e), preferably after the drying as defined in claim 77, more preferably after the calcining as defined in claim 77, the water-treated precursor of the molding is separated from the mixture obtained from (d), wherein separating preferably comprises subjecting the mixture obtained from (d) to filtration or centrifugation, wherein more preferably, separating further comprises washing the water-treated precursor of the molding at least once with a liquid solvent system, wherein the liquid solvent system preferably comprises one or more of water, an alcohol, and a mixture of two or more thereof, wherein the water-treated precursor of the molding is more preferably washed with water.
84. The method of any one of embodiments 56 to 83, wherein the calcining according to (g) of the dried catalyst molding obtained in step (e) is performed at a temperature ranging from 350 to 850 °C, preferably from 400 to 700 °C, more preferably from 450 to 650 °C, and more preferably from 475 to 600 °C.
85. A catalyst molding obtainable or obtained by a method according to any one of embodiments 56 to 84.
86. A process for the activation of hydrogen peroxide comprising:
   (1) providing a reactor comprising a catalyst molding for hydrogen peroxide activation according to any of embodiments 1 to 55 and 85;
   (2) contacting the catalyst molding provided in (1) with hydrogen peroxide.
87. The process of embodiment 86, wherein providing the catalyst molding in (1) comprises selecting the catalyst, which is comprised in the catalyst molding, among catalysts comprising Ti, Si, and O, and displaying
   a water adsorption (W), preferably determined according to Reference Example 1.1, and
   a concentration (C) of bridging μ²η²-peroxo species per Ti in the H₂O₂-activated catalyst as determined by quantitative ¹⁷O NMR spectroscopy, preferably according to Reference Example 1.3;
   wherein the catalyst, which is comprised in the catalyst molding, is selected by calculating an activation factor (A) in accordance with formula I for each of the catalysts, and selecting a catalyst displaying an activation factor in the range of from 10 to 75 mmol/mol, wherein the activation factor is the multiplication product of the water adsorption and the concentration of bridging μ²η²-peroxo species per Ti in the H₂O₂-activated catalyst:

A=W×C (I).
88. The process of embodiment 87, wherein providing the catalyst molding in (1) comprises selecting the catalyst, which is comprised in the catalyst molding, among catalysts displaying a water adsorption in the range of from 1 to 10 wt.-%, preferably from 1.5 to 9.5 wt.-%, more preferably from 2 to 9 wt.-%, more preferably from 2.5 to 8.5 wt.-%, more preferably from 3 to 8 wt.-%, more preferably from 3.2 to 7.9 wt.-%, more preferably from 3.5 to 7.5 wt.-%, more preferably from 4 to 7 wt.-%, more preferably from 4.5 to 6.5 wt.-%, and more preferably from 5 to 6 wt.-%.
89. The process of embodiment 88, wherein providing the catalyst molding in (1) comprises selecting the catalyst, which is comprised in the catalyst molding, among catalysts displaying a water adsorption in the range of from 3 to 6.5 wt.-%, preferably from 3.2 to 4.5 wt.-%, more preferably from 3.4 to 4.1 wt.-%.
90. The process of embodiment 87 to 89, wherein providing the catalyst molding in (1) comprises selecting the catalyst, which is comprised in the catalyst molding, among catalysts displaying a concentration of bridging μ²η²-peroxo species per Ti in the H₂O₂-activated catalyst in the range of from 150 to 1,000 mmol/mol, preferably from 100 to 800 mmol/mol, more preferably from 150 to 750 mmol/mol, more preferably from 200 to 700 mmol/mol, more preferably from 250 to 650 mmol/mol, more preferably from 300 to 600 mmol/mol, more preferably from 350 to 550 mmol/mol, and more preferably from 400 to 500 mmol/mol.
91. The process of any one of embodiments 87 to 90, wherein the catalyst, which is comprised in the catalyst molding, is selected by calculating an activation factor (A) for each of the catalysts, and selecting a catalyst displaying an activation factor in the range of from 11 to 65 mmol/mol, preferably from 13 to 55 mmol/mol, more preferably from 15 to 50 mmol/mol, more preferably from 18 to 45 mmol/mol, more preferably from 20 to 40 mmol/mol, more preferably from 21 to 39 mmol/mol, more preferably from 22 to 37 mmol/mol, more preferably from 23 to 35 mmol/mol, more preferably from 24 to 32 mmol/mol, and more preferably from 25 to 30 mmol/mol.
92. The process of any one of embodiments 87 to 91, wherein the concentration (C) of bridging μ²η²-peroxo species per Ti in the H₂O₂-activated catalyst as determined by quantitative ¹⁷O NMR spectroscopy is the concentration which is determined at a time point T after having brought the catalyst, which is comprised in the catalyst molding, into contact with H₂¹⁷O₂, wherein T is in the range of from 1 to 720 min after having brought the catalyst into contact with H₂¹⁷O₂, preferably from 2 min to 480 min after having brought the catalyst into contact with H₂¹⁷O₂, more preferably from 4 to 240 min after having brought the catalyst into contact with H₂¹⁷O₂, more preferably from 6 to 120 min after having brought the catalyst into contact with H₂¹⁷O₂, more preferably from 8 to 60 min after having brought the catalyst into contact with H₂¹⁷O₂, more preferably from 10 to 30 min after having brought the catalyst into contact with H₂¹⁷O₂, more preferably from 12 to 20 min after having brought the catalyst into contact with H₂¹⁷O₂, and more preferably from 14 to 16 min after having brought the catalyst into contact with H₂¹⁷O₂, wherein more preferably T is 15 min after having brought the catalyst into contact with H₂¹⁷O₂.
93. The process of embodiment 87, wherein providing the catalyst molding in (1) comprises selecting the catalyst, which is comprised in the catalyst molding, among catalysts displaying a concentration (C) of bridging μ²η²-peroxo species per Ti in the H₂O₂-activated catalyst as determined by quantitative ¹⁷O NMR spectroscopy in the range of from 125 to 750 mmol/mol, wherein the concentration (C) of bridging μ²η²-peroxo species per Ti in the H₂O₂-activated catalyst as determined by quantitative 170 NMR spectroscopy is the concentration which is determined at a time point T after having brought the catalyst into contact with H₂¹⁷O₂, wherein T is in the range of from 65 to 175 min.
94. The process of embodiment 93, wherein providing the catalyst molding in (1) comprises selecting the catalyst, which is comprised in the catalyst molding, among catalysts displaying a water adsorption in the range of from 1 to 7.9 wt.-%, preferably from 3 to 7.5 wt.-%, more preferably from 4 to 7 wt.-%, more preferably from 4.5 to 6.5 wt.-%.
95. The process of embodiment 94, wherein providing the catalyst molding in (1) comprises selecting the catalyst, which is comprised in the catalyst molding, among catalysts displaying a water adsorption in the range of from 3 to 6.5 wt.-%, preferably from 3.2 to 4.5 wt.-%, more preferably from 3.4 to 4.1 wt.-%.
96. The process of embodiment 93 to 95, wherein providing the catalyst molding in (1) comprises selecting the catalyst, which is comprised in the catalyst molding, among catalysts displaying a concentration (C) of bridging μ²η²-peroxo species per Ti in the H₂O₂-activated catalyst as determined by quantitative ¹⁷O NMR spectroscopy, preferably determined according to Reference Example 1.3, in the range of from 200 to 725 mmol/mol, preferably from 250 to 700 mmol/mol, more preferably from 300 to 680 mmol/mol, more preferably from 350 to 660 mmol/mol, more preferably from 400 to 640 mmol/mol, more preferably from 450 to 620 mmol/mol, and more preferably from 500 to 600 mmol/mol.
97. The process of any one of embodiments 93 to 96, wherein T is in the range of from 75 to 165 min after having brought the catalyst into contact with H₂¹⁷O₂, preferably from 85 min to 155 min after having brought the catalyst into contact with H₂¹⁷O₂, more preferably from 95 to 145 min after having brought the catalyst into contact with H₂¹⁷O₂, more preferably from 105 to 135 min after having brought the catalyst into contact with H₂¹⁷O₂, more preferably from 112 to 128 min after having brought the catalyst into contact with H₂¹⁷O₂, more preferably from 116 to 124 min after having brought the catalyst into contact with H₂¹⁷O₂, more preferably from 118 to 122 min after having brought the catalyst into contact with H₂¹⁷O₂, and more preferably from 119 to 121 min after having brought the catalyst into contact with H₂¹⁷O₂, wherein more preferably T is 120 min after having brought the catalyst into contact with H₂¹⁷O₂.
98. The process of any one of embodiments 93 to 97, wherein the activation factor (A) is in the range of from 11 to 70 mmol/mol, preferably from 12 to 62 mmol/mol, more preferably in the range of from 13 to 60 mmol/mol, more preferably from 14 to 59 mmol/mol, more preferably from 16 to 54 mmol/mol, more preferably from 18 to 49 mmol/mol, more preferably from 20 to 44 mmol/mol, more preferably from 21 to 39 mmol/mol, more preferably from 22 to 34 mmol/mol, more preferably from 23 to 31 mmol/mol, and more preferably from 24 to 28 mmol/mol.
99. The process of any one of embodiments 86 to 98, wherein providing the catalyst molding in (1) comprises selecting the catalyst, which is comprised in the catalyst molding, among catalysts comprising from 0 to 1 weight-%, preferably from 0 to 0.1 weight-%, more preferably from 0 to 0.01 weight-%, more preferably from 0 to 0.001 weight-%, of B, calculated as the element and based on the total weight of the catalyst, which is comprised in the catalyst molding.
100. The process of any one of embodiments 86 to 91, wherein providing the catalyst molding in (1) comprises selecting the catalyst, which is comprised in the catalyst molding, among catalysts comprising from 0 to 0.1 weight-%, more preferably from 0 to 0.08 weight-%, of Na, calculated as the element and based on the total weight of the catalyst, which is comprised in the catalyst molding.
101. The process of any one of embodiments 86 to 100, wherein providing the catalyst molding in (1) comprises selecting the catalyst, which is comprised in the catalyst molding, among catalysts comprising from 0 to 1 weight-%, preferably from 0 to 0.1 weight-%, more preferably from 0 to 0.01 weight-%, more preferably from 0 to 0.001 weight-%, of Ge, calculated as the element and based on the total weight of the catalyst, which is comprised in the catalyst molding.
102. The process of any one of embodiments 86 to 101, wherein providing the catalyst molding in (1) comprises selecting the catalyst, which is comprised in the catalyst molding, among catalysts comprising from 0 to 1 weight-%, preferably from 0 to 0.5 weight-%, more preferably from 0 to 0.2 weight-%, more preferably from 0 to 0.1 weight-%, more preferably from 0 to 0.01 weight-%, more preferably from 0 to 0.009 weight-%, more preferably from 0 to 0.005 weight-%, more preferably from 0 to 0.001 weight-%, of C, calculated as the element and based on the total weight of the catalyst, which is comprised in the catalyst molding.
103. The process of any one of embodiments 86 to 102, wherein providing the catalyst molding in (1) comprises selecting the catalyst, which is comprised in the catalyst molding, among catalysts comprising a content of one or more of Fe, Co, Ni, and Cu, calculated as Fe₂O₃, Co₂O₃, NiO, and CuO, respectively, in the range of from 0 to 0.1 weight-%, preferably in the range of from 0 to 0.07 weight-%, more preferably in the range of from 0 to 0.05 weight-%, more preferably in the range of from 0 to 0.02 weight-%, based on the weight of the catalyst which is comprised in the catalyst molding.
104. The process of any one of embodiments 86 to 102, wherein providing the catalyst molding in (1) comprises selecting the catalyst, which is comprised in the catalyst molding, among catalysts comprising a content of one or more of Fe, Co, Ni, and Cu, calculated as the element, respectively, in the range of from 0 to 0.1 weight-%, preferably in the range of from 0 to 0.07 weight-%, more preferably in the range of from 0 to 0.05 weight-%, more preferably in the range of from 0 to 0.02 weight-%, based on the weight of the catalyst which is comprised in the catalyst molding.
105. The process of any one of embodiments 86 to 104, wherein providing the catalyst molding in (1) comprises selecting the catalyst, which is comprised in the catalyst molding, among catalysts exhibiting a propylene oxide activity of at least 2.0 weight-%, preferably in the range of from 3.0 to 15.0 weight-%, more preferably in the range of from 5.0 to 14.0 weight-%, more preferably in the range of from 9.0 to 13.0 weight-%, preferably determined as described in Reference Example 1.6.
106. The process of any one of embodiments 86 to 105, wherein in (2) hydrogen peroxide is comprised in a liquid feed stream which is fed into the reactor, wherein the liquid feed stream further comprises one or more unsaturated organic compounds, preferably one or more olefins, more preferably one or more C₂-C₅ alkenes, more preferably one or more C₂-C₄ alkenes, more preferably one or more C₂ or C₃ alkenes, more preferably propylene.
107. The process of embodiment 106, wherein the liquid feed stream further comprises a solvent system, wherein the solvent system comprises one or more solvents, wherein preferably the solvent system comprises one or more hydrophilic solvents, the hydrophilic solvents preferably being selected from the group consisting of polar solvents, more preferably from the group consisting of polar protic solvents, wherein more preferably the solvent system comprises one or more polar protic solvents selected from the group consisting of water, alcohols, and mixtures of two or more thereof, more preferably from the group consisting of water, C₁-C₅ alcohols, C₁ to C₅ ethers, C₁ to C₅ nitriles, and mixtures of two or more thereof, more preferably from the group consisting of water, C₁-C₄ alcohols, C₁ to C₅ ethers, C₁ to C₄ nitriles, and mixtures of two or more thereof, more preferably from the group consisting of water, C₁-C₄ alcohols, C₁ to C₅ ethers, C₁ to C₃ nitriles, and mixtures of two or more thereof, more preferably from the group consisting of water, methanol, ethanol, propanol, tert-butanol, methyl tertbutyl ether (MTBE), acetonitrile, and mixtures of two or more thereof, more preferably from the group consisting of water, methanol, and mixtures thereof, wherein more preferably the solvent system comprises water, preferably water and methanol, wherein more preferably the solvent system consists of water and methanol.
108. The process of embodiment 106 or 107, wherein the liquid feed stream further comprises a potassium-containing compound, preferably a potassium salt, more preferably one or more of dipotassium hydrogen phosphate and a potassium salt of etidronic acid.
109. The process of any one of embodiments 106 to 108, wherein the liquid feed stream comprises hydrogen peroxide at a concentration in the range of from 1 to 75 weight-%, preferably from 3 to 50 weight-%, 5 to 30 weight-%, more preferably from 7 to 25 weight-%, more preferably from 8 to 20 weight-%, more preferably from 9 to 15 weight-%, more preferably from 10 to 12 weight-%, based on the total weight of the liquid feed stream.
110. The process of any one of embodiments 106 to 109, wherein the liquid feed stream fed into the reactor in (2) has a temperature in the range of from 0 to 60 °C, preferably from 25 to 50 °C.
111. The process of any one of embodiments 106 to 110, wherein the liquid feed stream fed into the reactor in (2) is at a pressure in the range of from 5 to 100 bar, preferably from 10 to 50 bar, more preferably from 15 to 25 bar.
112. The process of any one of embodiments 86 to 111, wherein contacting in (2) is conducted at a temperature in the range of from 10 to 100 °C, preferably from 25 to 80 °C, more preferably from 30 to 75 °C, more preferably from 32 to 65 °C.
113. The process of any one of embodiments 86 to 112, wherein contacting in (2) is conducted at a pressure in the range of from 5 to 100 bar, preferably from 10 to 50 bar, more preferably from 14 to 32 bar, more preferably from 15 to 25 bar, wherein the pressure is defined as the pressure at the exit of the reactor.
114. The process of any one of embodiments 86 to 113, wherein the catalyst molding loading in the reactor in (1) is in the range of from 0.05 to 5 h⁻¹, preferably from 0.1 to 3 h⁻¹, more preferably from 0.2 to 1 h⁻¹, more preferably from 0.200 to 0.5 h⁻¹, more preferably from 0.210 to 0.25 h⁻¹, more preferably from 0.215 to 0.240 h⁻¹, more preferably from 0.220 to 0.235 h⁻¹, more preferably from 0.225 to 0.230 h⁻¹, wherein the catalyst molding loading is defined as the ratio of the mass flow rate in kg/h of hydrogen peroxide contained in the liquid feed stream divided by the amount in kg of the catalyst molding comprised in the reactor in (1).
115. The process of any one of embodiments 86 to 114, wherein the process further comprises
   (3) removing an effluent stream from the reactor, the effluent stream comprising an oxidized organic compound, and preferably comprising an epoxidized organic compound, more preferably an alkylene oxide, more preferably an alkylene oxide selected from C₂-C₅ alkylene oxides, more preferably from C₂-C₄ alkylene oxides, more preferably from C₂ or C₃ alkylene oxides, more preferably from C₃ alkylene oxides, wherein more preferably the effluent stream comprises propylene oxide.
116. Use of the catalyst molding according to any one of embodiments 1 to 55 and 85 as a catalyst and/or catalyst component in a reaction involving one or more of C—O bond formation, C—C bond formation and C—C bond conversion, and preferably as a catalyst and/or catalyst component in an isomerization reaction, in an ammoximation reaction, in an amination reaction, in a hydrocracking reaction, in an alkylation reaction, in an acylation reaction, in a reaction for the conversion of alkanes to olefins, or in a reaction for the conversion of one or more oxygenates to olefins and/or aromatics, in a reaction for the synthesis of hydrogen peroxide, in an aldol condensation reaction, in a reaction for the isomerization of epoxides, in a transesterification reaction, in a hydroxylation reaction, in a Baeyer-Villiger-type oxidation reaction, in a Dakin-type reaction, or in an epoxidation reaction, preferably as a catalyst and/or catalyst component in a hydroxylation reaction, in a Baeyer-Villiger-type oxidation reaction, in a Dakin-type reaction, or in a reaction for the epoxidation of olefins, more preferably in a reaction for the epoxidation of olefins, more preferably in a reaction for the epoxidation of C₂-C₅ alkenes, more preferably in a reaction for the epoxidation of C₂-C₄ alkenes, in a reaction for the epoxidation of C₂ or C₃ alkenes, more preferably for the epoxidation of C₃ alkenes, and more preferably as a catalyst or catalyst component for the conversion of propylene to propylene oxide.
117. A process for preparing an olefin oxide comprising
   (A) providing olefin, hydrogen peroxide, water and organic solvent and optionally an additive into an epoxidation zone comprising the catalyst molding according to any one of claims 1 to 55 and 85, as a catalyst and/or catalyst component, obtaining a reaction mixture comprising olefin, hydrogen peroxide, water and organic solvent;
   (B) subjecting the reaction mixture obtained from (A) to epoxidation reaction conditions in the epoxidation zone, thereby obtaining a mixture comprising olefin oxide, water and organic solvent;
   (C) removing an effluent stream from the epoxidation zone, comprising olefin oxide, water and organic solvent.
118. The process of embodiment 117,
   wherein the olefin is a C₂-C₁₀ alkene, preferably a C₂-C₅ alkene, more preferably a C₂-C₄ alkene, more preferably ethylene or propylene, more preferably propylene;
   and/or, preferably and,
   wherein the organic solvent is an organic epoxidation solvent, wherein preferably the organic solvent is selected from the group consisting of C₁ to C₅ mono alcohol, C₁ to C₅ ether, C₁ to C₅ nitrile, and mixtures of two or more thereof, more preferably from the group consisting of tert-butanol, methanol, acetonitrile, methyl tert-butyl ether (MTBE), and mixtures of two or more thereof;
   and/or, preferably and,
   wherein the reaction mixture obtained in (A) preferably comprises the additive, wherein the additive is more preferably selected from the group consisting of potassium salt of an inorganic acid, potassium salt of an organic acid, ammonia, ammonium salt of an inorganic acid, ammonium salt of an organic acid and mixtures of two or more thereof; wherein the additive preferably comprises a potassium-containing compound, preferably a potassium salt, more preferably one or more of dipotassium hydrogen phosphate and a potassium salt of etidronic acid.

The present invention is further illustrated by the following examples, comparative examples and reference examples.

### EXPERIMENTAL SECTION

### Reference Example 1: Determination Methods

### Reference Example 1.1: Determination of Water Adsorption

Determination of the water adsorption properties of the examples of the experimental section was performed on a VTI SA instrument from TA Instruments following a step-isotherm program. The experiment consisted of a run, or a series of runs performed on a sample material that has been placed on the microbalance pan inside of the instrument. Before a measurement was started, residual moisture of a sample was removed by heating the sample to 120 °C (heating ramp of 5 °C/min) and holding it for 6 h under a N₂ flow. After the drying program, the temperature in the cell was decreased to 25 °C and kept isothermal during the measurements. The microbalance was calibrated, and the weight of the dried sample was balanced (maximum mass deviation 0.01 wt. %). Water uptake by the sample was measured as the increase in weight over that of the dry sample. First, an adsorption curve was measured by increasing the relative humidity (RH) to which the sample was exposed and measuring the water uptake by the sample at equilibrium. The RH was increased with a step of 10% from 5 to 85% and at each step the system controlled the RH and monitored the sample weight until reaching the equilibrium conditions and recording the weight uptake. The total adsorbed water amount by the sample was taken after the sample was exposed to 85% RH and expressed as weight percent relative to the weight of the dried sample. During the desorption measurement the RH was decreased from 85% to 5% with a step of 10% and the change in the weight of the sample (water uptake) was monitored and recorded.

### Reference Example 1.2: Determination of Ti K Edge XANES Spectra

Ti K edge XANES (X-ray absorption near edge structure) spectra were recorded at the European Synchrotron Radiation Facility (Grenoble, France). The X-ray beam was monochromatized using a liquid nitrogen cooled Si (111) monochromator. A calibration of the energy was performed using Ti reference foil (Ti K-edge position at 4966 eV). The XAS K-edge measurements were carried out with a fluorescent scheme of detection using a silicon drift diode with associated digital electronics. All samples were measured as pressed pellets.

Ti K edge XANES is highly sensitive to the local coordination sphere of Ti. Characteristic features can be observed both in the pre-edge and whiteline regions, respectively. For the analysis of Ti in titanium silicalite-1 (TS-1) and the determination of the structure of extraframework TiO₂, bulk TiO₂ references, e.g., anatase and rutile, were measured first. In this regard, anatase showed pre-edge features at 4969 eV, 4971 eV, 4972 eV and 4974 eV, respectively and a sharp first whiteline feature at 4987 eV. Rutile showed pre-edge features at 4969 eV, 4971 eV and 4974 eV, respectively, a moderate first whiteline feature at 4987 eV and a more pronounced feature at 4992 eV. For a titanosilicalite where all titanium is incorporated into the framework and in tetrahedral geometry, only one distinct feature at 4970 eV was observed in the pre-edge region and none in the whiteline region.

As regards the XANES spectrum of anatase, it displays a ratio of the intensity of the signal at 4987 eV to the intensity of the signal at 4992 eV of 1.07 (1.17:1.09=1.07). On the other hand, the XANES spectrum of rutile displays a ratio of the intensity of the signal at 4987 eV to the intensity of the signal at 4992 eV of 0.97 (1.12:1.16=0.97).

### Reference Example 1.3: Determination of the Concentration of Bridging μ²η²-Peroxo Species in an H₂O₂-Activated Catalyst Via ¹⁷O NMR SpectrosCopy

All NMR measurements were obtained on a Bruker Avance III 600-MHz NMR spectrometer (14.1 T) at low temperatures (100 K) using a 3.2-mm probe. The chemical shift was referenced against the signal of H₂O (at 100 K) to 0 ppm. Measurements were performed in a 3.2-mm sapphire rotor closed with a zirconia cap. Static WURST-CPMG (wideband, uniform-rate and smooth-truncation pulse with CPMG echo-train acquisition) experiments were performed to obtain the ¹⁷O NMR spectra. Details of the WURST pulse were as follows: length, 50 μs; 80 steps; sweep width, 0.5 MHz, sweeping from low to high frequency. SPINAL64 with 100 kHz radio frequency was used for 1H decoupling.

A TS-1 sample with ¹⁷O-labelled H₂O₂ was prepared by impregnating 25 mg of a TS-1 zeolite with one molar equivalent (with respect to Ti) of a 1.6 M aqueous solution of ¹⁷O-labelled H₂O₂. The samples were left to equilibrate for 15 min or 2 h before spectroscopic measurements.

For the determination of the concentration of bridging μ²η²-peroxo species in an H₂O₂-activated molding, a sample was prepared by impregnating 25 mg of a molding comprising a TS-1 zeolite with one molar equivalent (with respect to Ti) of a 1.1 M aqueous solution of ¹⁷O-labelled H₂O₂. The samples were left to equilibrate for 15 min or 2 h before spectroscopic measurements.

As indicated above, a sample was probed using solid-state ¹⁷O NMR spectroscopy at 100 K. This approach enabled the observation of reaction intermediates that originate from the activation of H₂¹⁷O₂, while at low temperature possible signal averaging due to dynamics was avoided and peroxo decomposition is prevented. The solid-state ¹⁷O NMR spectra of H₂¹⁷O₂ and H₂¹⁷O were also recorded, because these molecules were probably present in the catalyst sample.

The solid-state NMR spectra of the samples contacted with one equivalent (with respect to Ti) of H₂¹⁷O₂ solution for 2 h showed that H₂¹⁷O₂ reacted in all cases and that two new main signals of comparable intensity appeared.

To probe peroxo formation rates and stability a quantification protocol was established. First, a WURST QCMPG spectrum was measured (as described above) and subsequently the echo spectrum was reconstructed and then deconvolved into components associated with H₂O, H₂O₂ and peroxo species.

To avoid overfitting, the experimentally obtained spectrum of H₂O, H₂O₂ and peroxo were fitted individually using DM Fit. DM Fit is described by D. Massiot et al. in Magnetic Resonance in Chemistry 2002, vol. 40, pages 70-76.

The initial guess for each component was based on the previously DFT calculated NMR parameters in C. P. Gordon et al., Nature 2020, 586, 708-713, and the lineshape parameters of each species was optimized to converge to a best fit that provides the ratio of each species. Based on said DFT calculations the observed ¹⁷O NMR signals were assigned. The respective concentrations were obtained by multiplication of these ratios with the initial concentration (1.6 M or 1.1 M, respectively) of the aqueous stock solution of H₂¹⁷O₂ that was used for the wet impregnation.

The relative values for H₂¹⁷O₂, bridging μ²η²-peroxo, and H₂¹⁷O (see “rel. H₂O₂”, “rel. uperoxo” and “rel. H₂O” in table 1 below) after 15 min and after 2 hours were obtained from the measurements and applying the above quantification protocol.

The concentration of bridging μ²η²-peroxo species in a H₂¹⁷O₂-activated sample was calculated based on the value for the rel. bridging μ²η²-peroxo concentration according to the following calculation:

(concentration of bridging μ²η²-peroxo species)=[(rel. bridging μ²η²-peroxo concentration)×(concentration of H₂¹⁷O₂ solution)×(volume of ¹⁷O-labelled H₂O₂ solution used for wet impregnation)]/[weight of the catalyst sample in mg].

From said concentration the molar concentration of bridging μ²η²-peroxo species per titanium (i.e. mol bridging μ²η²-peroxo per mol Ti) was calculated.

### Reference Example 1.4: X-Ray Powder Diffraction and Determination of the Crystallinity

X-ray diffraction data are collected on a Cuk a Bragg-Brentano Bruker D8 Advance Series II diffractometer. The samples were ground using an IKA Tube Mill with 10000 U/min and then pressed into a standard flat sample holder provided by Bruker AXS GmbH for Bragg-Brentano geometry data collection. The flat surface was achieved using a glass plate to compress and flatten the sample powder. The angular range is 5°-50° (20) with a step width of 0.02° (20). Acquisition time is optimised to ensure that the highest intensity signal has at least 200′000 counts. The divergence slit is set to 0.3° opening angle. The total crystallinity is determined using a Rietveld based method as described by I. C. Madsen and N. V. Y. Scarlett, Chapter 11.3.2.1, in Powder Diffraction-Theory and Practice edited by R. E. Dinnebier and S. J. L. Billinge. The method is implemented in the data analysis software TOPAS (TOPAS 6 Users Manual, Bruker AXS GmbH, Karlsruhe, Germany).

To set up the model the instrumental parameters were encoded using the fundamental parameter approach (see TOPAS 6 Users Manual, Bruker AXS GmbH, Karlsruhe, Germany). The structure of a Ti doped MFI zeolite structure as described by Lamberti C., Bordiga S., Zecchina A., Carati A., Fitch A. N., Artioli G., Petrini G., Salvalaggio M., Marra G. L. “Structural Characterization of Ti-Silicalite-1: A Synchrotron Radiation X-Ray Powder Diffraction Study” in J. Catal. 1999, 183, 222-231 is added to the model. The amorphous content is modelled by collecting scattering data on an amorphous silica compound, obtained by drying colloidal silica (Ludox® AS40, dried at 120 °C). Using the approach described by I. C. Madsen and N. V. Y. Scarlett the amorphous content is modelled using a tetragonal lattice with a space group P4₁2₁2 (92). This selection generates 13 reflections within the scattering range when the lattice parameters a=b=5.07 Å, c=6.909 Å are used. The intensities are fit to the pure material. The crystallite size (LVol IB) of 0.6 ensures a good fit to the broad diffraction signals of amorphous material. For the refinement against data from a real sample the only parameter associated with the amorphous signal which is allowed to vary is that of the scale factor. The linear dependency of the mass fraction to the scattering intensity allows for a one-point calibration. This calibration value is determined and placed in lieu of the unit cell mass. The ZMV calculation then results in the value being reported witgh the accompanying structures. Crystallinity is then reported in the following manner:

Crystallinity=(Sum of Mass % crystalline material)/(Sum of Mass % crystalline material+amorphous material)

### Reference Example 1.5: Determination of the BET Specific Surface Area and the Micropore Volume

The BET specific surface area and the micropore volume were determined via nitrogen physisorption at 77 K according to the method disclosed in DIN ISO 9277 from 2014.

### Reference Example 1.6: Determination of the Propylene Oxide Activity (PO Test)

In the PO test, a preliminary test procedure to assess the possible suitability of the catalysts for the epoxidation of propylene, the catalysts (in particular catalyst powders) were tested in a glass autoclave by reaction of propylene with an aqueous hydrogen peroxide solution (30 weight-%) to yield propylene oxide. In particular, 0.5 g of a catalyst sample were introduced together with 45 ml of methanol in a glass autoclave, which was cooled to −25 °C. 20 ml of liquid propylene was pressed into the glass autoclave and the glass autoclave was heated to 0 °C. At this temperature, 18 g of an aqueous hydrogen peroxide solution (30 weight-% in water) were introduced into the glass autoclave. After a reaction time of 5 h at 0 °C, the mixture was heated to room temperature and the liquid phase was analyzed by gas chromatography with respect to its propylene oxide content. The propylene oxide content of the liquid phase (in weight-%) was the result of the PO test, i.e. the propylene oxide activity of the catalyst.

For the testing of catalyst moldings, the same procedure was used with the following modifications: the moldings were tested in a steel autoclave by reaction of propylene with an aqueous hydrogen peroxide solution (30 weight-%) to yield propylene oxide. In particular, 0.625 g of the molding were introduced together with 79.2 g of methanol in a steel autoclave. 23 ml of liquid propylene was pressed into the steel autoclave and the steel autoclave was heated to 40 °C. At this temperature, 22.1 g of an aqueous hydrogen peroxide solution (30 weight-% in water) were introduced into the steel autoclave followed by a further 9 g of methanol. After a reaction time of 4 h at 40 °C, the pressure was gently released, and the liquid phase was analyzed by gas chromatography with respect to its propylene oxide content.

### Reference Example 1.7: K-80 Test

The k80-test was designed as a semi-quantitative experiment to assess the rate of decomposition of H₂O₂ by TS-1 and similar titanium containing zeolites. It allows to quantitatively determine the effect of different catalyst treatments on the decomposition of H₂O₂.

### Experimental Procedure

In a clean 50 ml flask with a magnetic stirring bar and a thermometer were placed 30 g of deionised water and 6.5 g of a 40 weight-% hydrogen peroxide solution at room temperature (22 °C). At this point a t=0 probe of ca. 0.3 ml was taken with a pipette. The flask was lightly stoppered and then immersed in a previously equilibrated thermostating bath set to 80 °C. To obtain reproducible results it was important to use always the same amount of catalyst and to control the temperature to better than +1 °C during the experiment. As soon as the hydrogen peroxide solution was in thermal equilibrium with the thermostating bath, 500 mg (±1 mg) of the catalyst (either powder or extrudates) were added. The suspension was stirred, and samples of the supernatant liquid were then taken at regular intervals. The probe should be taken with a 1 ml syringe with a one-way filter Millipore Millex-HV SLHV 013 NL or equivalent. First 0.6 ml of solution were sucked into the syringe through the filter. Then 0.3 ml of the solution were backflushed through the filter into the flask. This was necessary in order to minimise loss of catalyst. The remaining 0.3 ml in the syringe were then used for the peroxide determination. The interval between probes was usually betweeη³⁰ and 60 min depending on the catalyst activity.

The experiment was finished after 7 hours.

### Analytics

The probes were analysed for H₂O₂ content by using a standard cerimetric titration. It was advisable to analyse the probes as soon as possible after they are collected. In order to ensure a good precision, the amount of titrating solution used should be at least 5 ml. If necessary, a larger amount of probe had to be weighed in.

### Data Analysis

The natural logarithm of the H₂O₂ concentration was plotted against time. Using least squares methods, the slope is extracted. This slope was the pseudo-first order decay rate of H₂O₂ in the presence of the catalyst (in h⁻¹) and was called the k80 value.

### Reference Example 1.8: Determination of the Crush Strength

The crush strength as referred to in the context of the present invention, is to be understood as having been determined via a crush strength test machine Z2.5/TS1S, supplier Zwick GmbH & Co., D-89079 Ulm, Germany. As to fundamentals of this machine and its operation, reference is made to the respective instructions handbook “Register 1: Betriebsanleitung/Sicherheitshandbuch für die Material-Prüfmaschine Z2.5/TS1S”, version 1.5, December 2001 by Zwick GmbH & Co. Technische Dokumentation, AugustNagel-Strasse 11, D-89079 Ulm, Germany. The machine was equipped with a fixed horizontal table on which the strand was positioned, with the longitudinal axis of the strand parallel to the horizontal table. A plunger with rectangular surface, having a width of 3 mm and depth of 10 mm, which was freely movable in vertical direction actuated the strand against the fixed table. The apparatus was operated with a preliminary force of 0.5 N, a shear rate under preliminary force of 10 mm/min and a subsequent testing rate of 1.6 mm/min. The vertically movable plunger was connected to a load cell for force pick-up and, during the measurement, moved toward the fixed turntable on which the molding (strand) to be investigated is positioned, thus actuating the strand against the table. The plunger was applied to the strands with the short edge of the plunger perpendicularly to the longitudinal axis of the strands. With said machine, a given strand as described below was subjected to an increasing force via the plunger until a break occurs. The force for breaking was referred to as the crushing strength of the strand.

Controlling the experiment was carried out by means of a computer which registered and evaluated the results of the measurements. The values obtained were the mean value of the measurements for 25 strands in each case. Thus, the obtained mean values are also referred to herein as average crush strength.

### Reference Example 1.9: Temperature Programmed Desorption of Ammonia (NH₃-TPD)

The temperature-programmed desorption of ammonia (NH₃-TPD) was conducted in an automated chemisorption analysis unit (Micromeritics AutoChem II 2920) having a thermal conductivity detector. Continuous analysis of the desorbed species was accomplished using an online mass spectrometer (OmniStar QMG200 from Pfeiffer Vacuum). The sample (0.1 g) was introduced into a quartz tube and analysed using the program described below. The temperature was measured by means of a Ni/Cr/Ni thermocouple immediately above the sample in the quartz tube. For the analyses, He of purity 5.0 was used. Before any measurement, a blank sample was analysed for calibration.
1. Preparation: Commencement of recording; one measurement per second. Wait for 10 minutes at 25 °C and a He flow rate of 30 cm³/min (room temperature (about 25 °C) and 1 atm); heat up to 600 °C at a heating rate of 20 K/min; hold for 10 minutes. Cool down under a He flow (30 cm³/min) to 100 °C at a cooling rate of 20 K/min (furnace ramp temperature); Cool down under a He flow (30 cm³/min) to 100 °C at a cooling rate of 3 K/min (sample ramp temperature).
2. Saturation with NH₃: Commencement of recording; one measurement per second. Change the gas flow to a mixture of 10% NH₃ in He (75 cm³/min; 100 °C and 1 atm) at 100 °C; hold for 30 minutes.
3. Removal of the excess: Commencement of recording; one measurement per second. Change the gas flow to a He flow of 75 cm³/min (100 °C and 1 atm) at 100 °C; hold for 60 min.
4. NH₃-TPD: Commencement of recording; one measurement per second. Heat up under a He flow (flow rate: 30 cm³/min) to 600 °C at a heating rate of 10 K/min; hold for 30 minutes.
5. End of measurement.

Desorbed ammonia was measured by means of the online mass spectrometer, which demonstrates that the signal from the thermal conductivity detector was caused by desorbed ammonia. This involved utilizing the m/z=16 signal from ammonia in order to monitor the desorption of the ammonia. The amount of ammonia adsorbed (mmol/g of sample) was ascertained by means of the Micromeritics software through integration of the TPD signal with a horizontal baseline.

### Reference Example 1.10: Determination of Activation Factor

An activation factor was determined for zeolitic materials as well as catalyst moldings being prepared in accordance with the present invention as well as for zeolitic materials and catalyst moldings not in accordance with the present invention. To this effect, the water adsorption (W), preferably determined according to Reference Example 1.1, and the concentration (C) of bridging μ²η²-peroxo species per Ti in the H₂O₂-activated zeolitic material, as determined by quantitative ¹⁷O NMR spectroscopy, preferably determined according to Reference Example 1.3, were determined. The activation factor (A) was calculated based thereon according to formula I, wherein in accordance with formula I, the activation factor is the multiplication product of the water adsorption and the concentration of bridging μ²η²-peroxo species per Ti in the H₂O₂-activated zeolitic material:

A=W×C (I).

### Reference Example 1.11: Determination of the Total Pore Volume

The total pore volume was determined via intrusion mercury porosimetry according to DIN 66133 from 1993.

### Example 1: Preparation of a TS-1 Catalyst in Accordance with the Present Invention

For the gel preparation, 500 g tetraethylorthosilicate (TEOS) and 3.75 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.81, determined with a pH sensitive glass electrode. The mixture was hydrolyzed at room temperature for 60 min during which the temperature rose to 60 °C. The mixture had a pH of 12.91, determined with a pH sensitive glass electrode, then. Afterwards the ethanol was distilled off until the sump reached a temperature of 95 °C. 546 g of distillate was obtained from distillation.

The synthesis gel was then cooled to 40 °C under stirring and 546 g de-ionized water added thereto. The resulting mixture had a pH of 11.91, determined with a pH sensitive glass electrode.

The synthesis gel was then transferred into an autoclave. The synthesis gel was heated under stirring in the autoclave to a temperature of 175 °C and stirred at said temperature for 16 h under autogenous pressure. The pressure was in the range of from 8.4 to 11.9 bar (abs). The resulting suspension was then worked-up. To this effect, the resulting suspension was diluted with de-ionized water, wherein the weight ratio of the suspension to de-ionized water was 1:1. Then, about 150 g nitric acid (10 weight-% in water) were added and the resulting mixture had a pH of 7.53. The obtained solids were filtered off and washed three times with de-ionized water (each time 1000 ml de-ionized water were used). Subsequently, the solids were dried in an oven in air at 120 °C for 4 h and then calcined in air at 490 °C for 5 h, wherein the heating rate for calcining was 2 °C/min.

The resulting product had a Si content of 44 weight-%, a Ti content of 0.52 weight-%, and a total organic carbon content (TOC) of less than 0.1 weight-%. The BET specific surface area of the resulting product was 443 m²/g determined according to Reference Example 1.5, and the water adsorption 7.5 wt.-% determined according to Reference Example 1.1. The crystallinity was 96% and no anatase was detectable by X-ray diffraction, as determined according to Reference Example 1.4.

The XANES spectrum of the product was determined according to Reference Example 1.2, wherein the catalyst displays a ratio of the intensity of the signal at 4987 eV to the intensity of the signal at 4992 eV of 0.95 (1.03:1.08=0.95). The results for the PO test and for the K80-test, determined according to Reference Examples 1.6 and 1.7, respectively, are shown in tables 4 and 5, respectively.

### Example 2: Preparation of a TS-1 Catalyst in Accordance with the Present Invention

For the gel preparation, 500 g tetraethylorthosilicate (TEOS) and 7.5 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.81, determined with a pH sensitive glass electrode. The mixture was hydrolyzed at room temperature for 60 min during which the temperature rose to 60 °C. The mixture had a pH of 12.71, determined with a pH sensitive glass electrode, then. Afterwards the ethanol was distilled off until the sump reached a temperature of 95 °C. 548 g of distillate was obtained from distillation.

The synthesis gel was then cooled to 40 °C under stirring and 548 g de-ionized water added thereto. The resulting mixture had a pH of 12.01, determined with a pH sensitive glass electrode.

The synthesis gel was then transferred into an autoclave. The synthesis gel was heated under stirring in the autoclave to a temperature of 175 °C and stirred at said temperature for 16 h under autogenous pressure. The pressure was in the range of from 8.2 to 11.4 bar (abs). The resulting suspension was then worked-up. To this effect, the resulting suspension was diluted with de-ionized water, wherein the weight ratio of the suspension to de-ionized water was 1:1. Then, about 155 g nitric acid (10 weight-% in water) were added and the resulting mixture had a pH of 7.28, determined with a pH sensitive glass electrode. The obtained solids were filtered off and washed three times with de-ionized water (each time 1000 ml de-ionized water were used). Subsequently, the solids were dried in an oven in air at 120 °C for 4 h and then calcined in air at 490 °C for 5 h, wherein the heating rate for calcining was 2 °C/min.

The resulting product had a Si content of 43 weight-%, a Ti content of 1.0 weight-%, and a total organic carbon content (TOC) of less than 0.1 weight-%. The BET specific surface area of the resulting product was 450 m²/g determined according to Reference Example 1.5, and the water adsorption 8.45 wt.-% determined according to Reference Example 1.1. The crystallinity was 100% and no anatase was detectable by X-ray diffraction, determined according to Reference Example 1.3.

The XANES spectrum of the product was determined according to Reference Example 1.2, wherein the catalyst displays a ratio of the intensity of the signal at 4987 eV to the intensity of the signal at 4992 eV of 0.96 (1.05:1.09=0.96). The results for the PO test and for the K80-test, determined according to Reference Examples 1.6 and 1.7, respectively, are shown in tables 4 and 5, respectively.

### Example 3: Preparation of a TS-1 Catalyst in Accordance with the Present Invention

For the gel preparation, 500 g tetraethylorthosilicate (TEOS) and 11.25 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.79, determined with a pH sensitive glass electrode. The mixture was hydrolyzed at room temperature for 60 min during which the temperature rose to 60 °C. The mixture had a pH of 12.85, determined with a pH sensitive glass electrode, then. Afterwards the ethanol was distilled off until the sump reached a temperature of 95 °C. 546 g of distillate was obtained from distillation.

The synthesis gel was then cooled to 40 °C under stirring and 546 g de-ionized water added thereto. The resulting mixture had a pH of 11.86, determined with a pH sensitive glass electrode.

The synthesis gel was then transferred into an autoclave. The synthesis gel was heated under stirring in the autoclave to a temperature of 175 °C and stirred at said temperature for 16 h under autogenous pressure. The pressure was in the range of from 8.4 to 11.9 bar (abs). The resulting suspension was then worked-up. To this effect, the resulting suspension was diluted with de-ionized water, wherein the weight ratio of the suspension to de-ionized water was 1:1. Then, about 150 g nitric acid (10 weight-% in water) were added and the resulting mixture had a pH of 7.31, determined with a pH sensitive glass electrode. The obtained solids were filtered off and washed three times with de-ionized water (each time 1000 ml de-ionized water were used). Subsequently, the solids were dried in an oven in air at 120 °C for 4 h and then calcined in air at 490 °C for 5 h, wherein the heating rate for calcining was 2 °C/min.

The resulting product had a Si content of 42 weight-%, a Ti content of 1.5 weight-%, and a total organic carbon content (TOC) of less than 0.1 weight-%. The BET specific surface area of the resulting product was 449 m²/g determined according to Reference Examples 1.5, and the water adsorption 9.6 wt.-% determined according to Reference Examples 1.1. The crystallinity was 96% and no anatase was detectable by X-ray diffraction, as determined according to Reference Examples 1.4.

The XANES spectrum of the product was determined according to Reference Examples 1.2, wherein the catalyst displays a ratio of the intensity of the signal at 4987 eV to the intensity of the signal at 4992 eV of 0.98 (1.06:1.08=0.98). The results for the PO test and for the K80-test, determined according to Reference Examples 1.6 and 1.7, respectively, are shown in tables 4 and 5, respectively.

### Example 4: Preparation of a TS-1 Catalyst in Accordance with the Present Invention

For the gel preparation, 500 g tetraethylorthosilicate (TEOS) and 15 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.83, determined with a pH sensitive glass electrode. The mixture was hydrolyzed at room temperature for 60 min during which the temperature rose to 60 °C. The mixture had a pH of 12.71, determined with a pH sensitive glass electrode, then. Afterwards the ethanol was distilled off until the sump reached a temperature of 95 °C. 558 g of distillate was obtained from distillation.

The synthesis gel was then cooled to 40 °C under stirring and 558 g de-ionized water added thereto. The resulting mixture had a pH of 11.95, determined with a pH sensitive glass electrode.

The synthesis gel was then transferred into an autoclave. The synthesis gel was heated under stirring in the autoclave to a temperature of 175 °C and stirred at said temperature for 16 h under autogenous pressure. The pressure was in the range of from 8.4 to 11.4 bar (abs). The resulting suspension was then worked-up. To this effect, the resulting suspension was diluted with de-ionized water, wherein the weight ratio of the suspension to de-ionized water was 1:1. Then, about 152 g nitric acid (10 weight-% in water) were added and the resulting mixture had a pH of 7.21, determined with a pH sensitive glass electrode. The obtained solids were filtered off and washed three times with de-ionized water (each time 1000 ml de-ionized water were used). Subsequently, the solids were dried in an oven in air at 120 °C for 4 h and then calcined in air at 490 °C for 5 h, wherein the heating rate for calcining was 2 °C/min.

The resulting TS-1 material had a Si content of 43 weight-%, a Ti content of 2 weight-%, and a total organic carbon content (TOC) of less than 0.1 weight-%. The BET specific surface area of the resulting TS-1 material was 447 m²/g determined according to Reference Examples 1.5. The crystallinity was 92%, and about 0.5% of anatase were detectable by X-ray diffraction, as determined according to Reference Examples 1.4.

Then, 382.0 g deionized water were provided in a beaker. 150.9 g tetrapropylammonium hydroxide (as an aqueous solution comprising 40 weight-% tetrapropylammonium hydroxide) were added under stirring. Subsequently, 71.0 g of the TS-1 material were added. This mixture was homogenized for 30 min. The mixture was then transferred into an autoclave. The mixture was hydrothermally treated at 170 °C for 6 hours. The resulting solids were separated via centrifugation, and the solid residue obtained was washed with deionized water. The resulting solid was dried in air at 120 °C for 4 h and calcined in air at 490 °C for 5 h in an oven.

The resulting TS-1 product had a Si content of 44 weight-%, a Ti content of 1.9 weight-%, and a total organic carbon content (TOC) of less than 0.1 weight-%. The BET specific surface area of the resulting TS-1 product was 446 m²/g determined according to Reference Examples 1.5, and the water adsorption 7.25 wt.-% determined according to Reference Examples 1.1. The crystallinity was 93%, and about 0.7% of anatase were detectable by X-ray diffraction, as determined according to Reference Examples 1.4.

The XANES spectrum of the product was determined according to Reference Examples 1.2, wherein the catalyst displays a ratio of the intensity of the signal at 4987 eV to the intensity of the signal at 4992 eV of 1.03 (1.13:1.10=1.03). The results for the PO test and for the K80-test determined according to Reference Examples 1.6 and 1.7, respectively, are shown in tables 4 and 5, respectively.

### Example 5: Preparation of a TS-1 Catalyst in Accordance with the Present Invention

A TS-1 zeolite was prepared in accordance with Example 1 of WO 2011/064191 A1 with the exception that 10 weight-% of tetraethyl orthosilicate were used as binder based oη¹⁰⁰ weight-% of the TS-1 material.

1072 g de-ionized water were provided in a beaker. Then, 424 g tetrapropylammonium hydroxide (as an aqueous solution comprising 40 weight-% tetrapropylammonium hydroxide) were added under stirring. Subsequently, 200 g of the TS-1 zeolite were added. This mixture was homogenized for 30 min. The mixture was then transferred in an autoclave, where it was hydrothermally treated at 170 °C for 24 hours. The resulting solids were separated via centrifugation, and the solid residue obtained was washed with deionized water. The resulting solid material was heated in air withiη⁶⁰ min to a temperature of 110 °C and dried at said temperature for 4 h. Then, the resulting solid material was heated in air withiη¹⁹⁰ min to a temperature of 520 °C and calcined at said temperature for 16 h.

The thus obtained TS-1 material had a Si content of 45 weight-%, a Ti content of 1.7 weight-% and a total organic carbon content (TOC) of less than 0.1 weight-%. The BET specific surface area was 450 m²/g determined according to Reference Example 1.5.

5000 g of aqueous nitric acid (10 weight-% HNO3 in water) were provided in a glass beaker. Under stirring, 250 g of the TS-1 material were added thereto. The resulting suspension—while being stirred at 250 rpm—was refluxed at 100 °C for 1 hour. For work-up, the resulting solids were separated via centrifugation. The resulting solid material was heated in air withiη⁶⁰ min to a temperature of 120 °C and dried at said temperature for 4 h. Then, the resulting solid material was heated in air withiη¹⁹⁰ min to a temperature of 500 °C and calcined at said temperature for 5 h.

The thus obtained TS-1 material had a Si content of 45 weight-%, a Ti content of 1.8 weight-% and a total organic carbon content (TOC) of less than 0.1 weight-%. The BET specific surface area was 453 m²/g determined according to Reference Example 1.5, and the water adsorption 7.0 wt.-% determined according to Reference Example 1.1. The crystallinity was 97%, and about 1% of anatase were detectable by X-ray diffraction, as determined according to Reference Example 1.4. The results for the PO test and for the K80-test, determined according to Reference Examples 1.6 and 1.7, respectively, are shown in tables 4 and 5, respectively.

### Example 6: Preparation of a Catalyst in Accordance with the Present Invention

Using a modified synthetic procedure, a TS-1 material was synthesized having an Si content of 44 weight-%, a Ti content of 1.2 weight-%, and a total organic carbon content (TOC) of less than 0.1 weight-%. The BET specific surface area of the TS-1 material was 429 m²/g determined according to Reference Example 1.5, the micropore volume was 0.07 ml/g, the total pore volume was 0.37 ml/g determined according to Reference Example 1.11, and the water adsorption 3.4 wt.-% determined according to Reference Example 1.1. The crystallinity was 100% as determined by X-ray diffraction determined according to Reference Example 1.4.

The XANES spectrum of the product was determined according to Reference Example 1.2, wherein the catalyst displays a ratio of the intensity of the signal at 4987 eV to the intensity of the signal at 4992 eV of 0.99 (1.07:1.08=0.99). The results for the PO test and for the K80-test, determined according to Reference Examples 1.6 and 1.7, respectively, are shown in tables 4 and 5, respectively.

### Example 7: Preparation of a Catalyst in Accordance with the Present Invention

Using a modified synthetic procedure, a TS-1 material was synthesized having an Si content of 46 weight-%, a Ti content of 1.2 weight-%, and a total organic carbon content (TOC) of less than 0.1 weight-%. The BET specific surface area of the resulting TS-1 material was 392 m²/g determined according to Reference Example 1.5, the micropore volume was 0.06 ml/g, the total pore volume was 0.39 ml/g determined according to Reference Example 1.11, and the water adsorption 4.4 wt.-% determined according to Reference Example 1.1. The crystallinity was 89%, and about 0.9% of anatase were detectable by X-ray diffraction determined according to Reference Example 1.4.

The XANES spectrum of the product was determined according to Reference Example 1.2, wherein the catalyst displays a ratio of the intensity of the signal at 4987 eV to the intensity of the signal at 4992 eV of 1.07 (1.16:1.08=1.07). The results for the PO test and for the K80-test, determined according to Reference Examples 1.6 and 1.7, respectively, are shown in tables 4 and 5, respectively.

### Comparative Example 8: Preparation of a Catalyst of the Prior Art

For the gel preparation, 496.7 g tetraethylorthosilicate (TEOS) and 21.8 g tetraethylorthotitanate (TEOTi; Merck) were filled into a beaker. Then, a solution of 298.3 g de-ionized water and 218.2 g aqueous tetrapropylammonium hydroxide (TPAOH; 40 weight-% in water) was added under stirring (200 rpm). The mixture was hydrolyzed at room temperature for 60 min during which the temperature rose to 60 °C. Afterwards the ethanol was distilled off until the sump reached a temperature of 85 °C. 450 g of distillate was obtained from distillation.

The synthesis gel was then cooled to 40 °C under stirring and 450 g de-ionized water added thereto. The resulting mixture had a pH of 12.1, determined with a pH sensitive glass electrode.

The synthesis gel was then transferred into an autoclave. The synthesis gel was heated under stirring in the autoclave to a temperature of 175 °C and stirred at said temperature for 16 h under autogenous pressure. The resulting suspension was then worked-up. To this effect, the resulting suspension was diluted with de-ionized water, wherein the weight ratio of the suspension to de-ionized water was 1:1. Then, 178.6 g nitric acid (10 weight-% in water) were added. The pH was adjusted to 7 with about 3 ml of NH₄OH solution (25 weight-% NH₄OH in water). The obtained solids were filtered off and washed three times with de-ionized water (each time 1000 ml de-ionized water were used). Subsequently, the solids were dried in an oven in air at 120 °C for 4 h and then calcined in air at 490 °C for 5 h, wherein the heating rate for calcining was 2 °C/min.

The resulting TS-1 material had a Si content of 43 weight-%, a Ti content of 2.8 weight-%, and a total organic carbon content of 0.6 weight-%. The BET specific surface area of the resulting TS-1 material was 434 m²/g determined according to Reference Example 1.5. The crystallinity was 81%, and about 0.7% of anatase were detectable by X-ray diffraction determined according to Reference Example 1.4. The results for the PO test and for the K80-test, determined according to Reference Examples 1.6 and 1.7, respectively, are shown in tables 4 and 5, respectively.

### Comparative Example 9: Preparation of a Catalyst of the Prior Art

For the gel preparation, 500 g tetraethylorthosilicate (TEOS) and 15 g tetraethylorthotitanate (TEOTi; Merck) were filled into a beaker. Then, a solution of 300 g de-ionized water and 220 g aqueous tetrapropylammonium hydroxide (TPAOH; 40 weight-% in water) was added under stirring (200 rpm). The resulting mixture had a pH of 13.5, determined with a pH sensitive glass electrode. The mixture was hydrolyzed at room temperature for 60 min during which the temperature rose to 60 °C. The mixture had a pH of 12.6, determined with a pH sensitive glass electrode, then. Afterwards the ethanol was distilled off until the sump reached a temperature of 95 °C. 540 g of distillate was obtained from distillation.

The synthesis gel was then cooled to 40 °C under stirring and 542 g de-ionized water added thereto. The resulting mixture had a pH of 11.9, determined with a pH sensitive glass electrode.

The synthesis gel was then transferred into an autoclave. The synthesis gel was heated under stirring in the autoclave to a temperature of 175 °C and stirred at said temperature for 16 h under autogenous pressure. The pressure was in the range of from 8.4 to 10.9 bar (abs). The resulting suspension was then worked-up. To this effect, the resulting suspension was diluted with de-ionized water, wherein the weight ratio of the suspension to de-ionized water was 1:1. Then, about 164 g nitric acid (10 weight-% in water) were added and the resulting mixture had a pH of 7.35. The obtained solids were filtered off and washed four times with de-ionized water (each time 1000 ml de-ionized water were used). Subsequently, the solids were dried in an oven in air at 120 °C for 16 h and then calcined in air at 490 °C for 5 h, wherein the heating rate for calcining was 2 °C/min.

The thus obtained TS-1 material had a Si content of 43 weight-%, a Ti content of 2 weight-% and a total organic carbon content of less than 0.1 weight-%. The BET specific surface area was 462 m²/g determined according to Reference Example 1.5, and the water adsorption 11.5 wt.-% determined according to Reference Example 1.1. The crystallinity was 88% as determined by X-ray diffraction determined according to Reference Example 1.4.

The XANES spectrum of the product was determined according to Reference Example 1.2, wherein the catalyst displays a ratio of the intensity of the signal at 4987 eV to the intensity of the signal at 4992 eV of 0.97 (1.05:1.08=0.97). The results for the PO test and for the K80-test, determined according to Reference Examples 1.6 and 1.7, respectively, are shown in tables 4 and 5, respectively.

### Example 10: Preparing a Catalyst in Accordance with the Present Invention (TS-1)

A titanium silicalite-1 (TS-1) powder was prepared according to the following recipe: 500 g TEOS (tetraethyl orthosilicate) and 15 g TEOTi (tetraethyl orthotitanate) were loaded into a four-neck flask at room temperature and stirring (200 rpm) was started. Then, 220 g of an aqueous solution comprising 40 weight-% TPAOH (tetrapropylammonium hydroxide) and 300 g of deionized water were added. The pH of the resulting solution was 14.21, determined with a pH sensitive glass electrode. Stirring was continued for 60 min, whereby the temperature of the mixture rose to 60 °C. Ethanol released by hydrolysis was separated by distillation at a bottoms temperature of 95 °C, obtaining about 540 g ethanol and a gel. The pH of the gel was 12.34, determined with a pH sensitive glass electrode. Subsequently, the gel was cooled down to 40 °C under stirring and 540 g of deionized water were added. The pH of the obtained mixture was 12.01, determined with a pH sensitive glass electrode. Crystallization was performed in an autoclave under stirring at 175 °C withiη¹⁶ h and 20 min at autogenous pressure.

The obtained suspension was worked-up as follows. The suspension was diluted 1:1 with deionized water under stirring (200 rpm, Teflon anchor stirrer) and precipitated with 10% HNO3 (approx. 130 g) at pH 7.31, determined with a pH sensitive glass electrode, and filtered off through a porcelain suction filter (blue belt filter). The filter cake was washed 3 times with 1000 ml deionized water, dried in an oven for 4 h at 120 °C and calcined for 5 h at 490 °C (heating rate 2 °C/min) in air.

The yield was 148 g. The resulting powder had a total organic carbon content (TOC) of 0.02 g/100 g, determined according to DIN EN 1484, a potassium content of less than 0.01 g/100 g, a sodium content of 0.01 g/100 g, a Si content of 43 g/100 g, and a Ti content of 1.9 g/100 g. As determined by X-ray diffraction analysis according to Reference Example 1.4, the sample had a crystallinity of 91% and essentially consisted of TS-1 (100 weight-% of crystalline TS-1).

750.0 g deionized water and 300 g of an aqueous solution comprising 40 weight-% tetrapropylammonium hydroxide were provided in a beaker. Then, 140 g of the prepared TS1 powder were added under stirring (200 rpm, anchor stirrer). This mixture was stirred for 60 min, and then transferred in an autoclave. The mixture was then heated to 170 °C under stirring and stirred for 84 h at 170 °C under autogenous pressure. The obtained suspension was worked-up as follows. The suspension was filled into beakers and centrifuged for 60 min with 4000 rpm. The solids were dried in an oven for 10 h at 120 °C and then calcined for 5 h at 490 °C (heating rate 2 °C/min) in air.

The yield was 121 g. The resulting powder had a Ti content of 1.8 g/100 g, a water adsorption of 6.3 weight-% determined according to Reference Example 1.1, and showed a BET specific surface area of 443 m²/g determined as described in Reference Example 1.5.

### Example 11: Preparing a Catalyst Molding in Accordance with the Present Invention

100.0 g of the zeolitic material of Example 10 and 4.0 g Walocel™ (Walocel MW 15000 GB, Wolff Cellulosics GmbH & Co. KG, Germany) were provided in a kneader and mixed for 5 minutes. Then, 111.0 g of polystyrene (33 wt.-% aqueous dispersion) were added, and the resulting mixture kneaded for 10 minutes. Then, 1.33 g of polyethylene oxide (PEO) were added, and the resulting mixture kneaded for 10 minutes. Then, 83.3 g of an aqueous suspension comprising 40 weight-% colloidal silica (Ludox® AS 40) were added and the resulting mixture kneaded for 10 minutes. Subsequently, 25.0 g deionized water were added, and the resulting mixture kneaded for 15 minutes.

After that, the kneaded mass was subjected to shaping. For shaping, the kneaded mass was extruded at a pressure of 150 bar (abs) to give strands with a circular cross-section having a diameter of 1.9 mm. The strands were then dried in an oven for 4 h at 120 °C and then calcined in air for 5 h at 490 °C (heating rate: 2 °C/min).

The yield was 124 g. The obtained material had a water adsorption of 6.7 weight-% determined according to Reference Example 1.1, a bulk density of 332 g/l, a total pore volume of 0.957 ml/g determined as described in Reference Example 1.11. As determined by X-ray diffraction analysis according to Reference Example 1.4, the sample had a crystallinity of 58% and essentially consisted of TS-1 (0.7 weight-% crystalline anatase and 99.3 weight-% of crystalline TS-1).

50.0 g of the prepared strands were loaded into an autoclave. Then, 750 g deionized water were added. The resulting mixture was heated to a temperature of 145 °C for 8 h in an autoclave. Thereafter, the obtained water-treated strands were separated and sieved over a 800 μm sieve. The obtained strands were then washed with deionized water and dried in an oven for 4 h at 120 °C (heating rate: 2 °C/min) in air and then calcined for 2 h at 450 °C (heating rate: 2 °C/min) in air.

The resulting material had a Ti content of 1.4 g/100 g, a water adsorption of 4.5 weight-% determined according to Reference Example 1.1, and a bulk density of 332 g/l. Furthermore, the resulting material dislayed a K-80 test value of 0.06 h⁻¹ as determined according to Reference Example 4 As determined by X-ray diffraction analysis according to Reference Example 1.4, the sample had a crystallinity of 51%.

### Example 12: Preparing a Catalyst Molding According to the Invention

100.0 g of the zeolitic material of Example 7 and 4.0 g Walocel™ (Walocel MW 15000 GB, Wolff Cellulosics GmbH & Co. KG, Germany) were provided in a kneader and mixed for 5 minutes. Then, 111.0 g of polystyrene (33 wt.-% aqueous dispersion) were added, and the resulting mixture kneaded for 10 minutes. Then, 1.33 g of polyethylene oxide (PEO) were added, and the resulting mixture kneaded for 10 minutes. Then, 83.3 g of an aqueous suspension comprising 40 weight-% colloidal silica (Ludox® AS 40) were added and the resulting mixture kneaded for 10 minutes.

Subsequently, 25.0 g deionized water were added, and the resulting mixture kneaded for 15 minutes.

After that, the kneaded mass was subjected to shaping. For shaping, the kneaded mass was extruded at a pressure of 150 bar (abs) to give strands with a circular cross-section having a diameter of 1.9 mm. The strands were then dried in an oven for 4 h at 120 °C and then calcined in air for 5 h at 490 °C (heating rate: 2 °C/min).

40.0 g of the prepared strands were loaded into an autoclave. Then, 600 g deionized water were added. The resulting mixture was heated to a temperature of 145 °C for 8 h in an autoclave. Thereafter, the obtained water-treated strands were separated and sieved over a 800 μm sieve. The obtained strands were then washed with deionized water and dried in an oven for 4 h at 120 °C (heating rate: 2 °C/min) in air and then calcined for 2 h at 450 °C (heating rate: 2 °C/min) in air.

The resulting material had a Ti content of 0.9 g/100 g, a water adsorption of 5.3 weight-% determined according to Reference Example 1.1.

### Reference Example 1.12: Activation Factor of Examples and Comparative Examples

For determining the activation factor of the prepared catalysts, the concentration of bridging μ²η²-peroxo species per Ti in the H₂O₂-activated catalyst (“mmol μ-peroxo species/mol Ti”) was determined for the examples and comparative examples according to the method described in Reference Example 1.3, wherein the concentration was determined 15 min and 2 h after having activated the respective samples with hydrogen peroxide. Based thereon, the activation factor was calculated according to Reference Example 1.10.

TABLE 1
Overview of relative values for H₂¹⁷O₂, bridging μ² η²-peroxo (“μ-peroxo”),
and H₂¹⁷O after 15 min and after 2 hours as obtained from the measurements and
application of the quantification protocol described in Reference Example 1.3.

| | Ti | rel. | rel. μ- | rel. | rel. | rel. μ- | rel. |
|---|---|---|---|---|---|---|---|
| | content | H₂¹⁷O₂ | peroxo | H₂¹⁷O | H₂¹⁷O₂ | peroxo | H₂¹⁷O |
| # | [wt.-%] | (15 min) | (15 min) | (15 min) | (2 h) | (2 h) | (2 h) |
| Ex. 1 | 0.52 | 0.23 | 0.41 | 0.36 | 0.07 | 0.46 | 0.47 |
| Ex. 2 | 1.0 | 0.24 | 0.53 | 0.23 | 0.07 | 0.58 | 0.35 |
| Ex. 3 | 1.5 | 0.31 | 0.54 | 0.15 | 0.04 | 0.72 | 0.25 |
| Comp. | 2.0 | 0.21 | 0.66 | 0.13 | 0.04 | 0.80 | 0.16 |
| Ex. 9 | | | | | | | |
| Ex. 4 | 1.9 | 0.42 | 0.41 | 0.17 | 0.08 | 0.61 | 0.31 |
| Comp. | 2.8 | 0.23 | 0.66 | 0.11 | 0.07 | 0.76 | 0.17 |
| Ex. 8 | | | | | | | |
| Ex. 6 | 1.2 | 0.00 | 0.77 | 0.23 | 0.00 | 0.68 | 0.32 |
| Ex. 7 | 1.2 | 0.00 | 0.67 | 0.33 | 0.00 | 0.59 | 0.41 |
| Ex. 5 | 1.8 | 0.00 | 0.65 | 0.35 | 0.00 | 0.54 | 0.46 |
| Ex. 10 | 1.8 | 0.33 | 0.35 | 0.32 | 0.26 | 0.34 | 0.40 |
| Ex. 12 | 0.9 | 0.31 | 0.45 | 0.25 | 0.11 | 0.48 | 0.40 |

TABLE 2
Overview of concentrations of H₂¹⁷O₂, bridging μ²
η²-peroxo (“μ-peroxo”), and H₂¹⁷O after 15 min as
calculated according Reference Example 1.3 and based
on the value of the to respective rel. concentration.

| | | conc. | conc. | conc. |
|---|---|---|---|---|
| | Ti | H₂¹⁷O₂ | μ-peroxo | H₂¹⁷O |
| | content | (15 min) | (15 min) | (15 min) |
| # | [wt .- %] | [μmol/mg] | [μmol/mg] | [μmol/mg] |
| Ex. 1 | 0.5 | 0.024 | 0.042 | 0.037 |
| Ex. 2 | 1.0 | 0.050 | 0.112 | 0.049 |
| Ex. 3 | 1.5 | 0.099 | 0.168 | 0.046 |
| Comp. | 2.0 | 0.086 | 0.276 | 0.054 |
| Ex. 9 | | | | |
| Ex. 4 | 1.9 | 0.167 | 0.164 | 0.066 |
| Comp. | 2.8 | 0.132 | 0.385 | 0.066 |
| Ex. 8 | | | | |
| Ex. 6 | 1.2 | 0.000 | 0.192 | 0.057 |
| Ex. 7 | 1.2 | 0.000 | 0.166 | 0.083 |
| Ex. 5 | 1.8 | 0.000 | 0.247 | 0.131 |
| Ex. 10 | 1.8 | 0.125 | 0.132 | 0.121 |
| Ex. 12 | 0.9 | 0.059 | 0.086 | 0.047 |

TABLE 3
Overview of concentrations of H₂¹⁷O₂, bridging μ² η²-peroxo (“μ-peroxo”),
and H₂¹⁷O after 2 h as calculated according to Reference Example 1.3 and
based on the value of the respective rel. concentration.

| | | conc. H₂¹⁷O₂ | conc. μ-peroxo | conc. H₂¹⁷O |
|---|---|---|---|---|
| | Ti content | (2 h) | (2 h) | (2 h) |
| # | [wt .- %] | [μmol/mg] | [μmol/mg] | [μmol/mg] |
| Ex. 1 | 0.5 | 0.007 | 0.047 | 0.048 |
| Ex. 2 | 1.0 | 0.016 | 0.122 | 0.073 |
| Ex. 3 | 1.5 | 0.011 | 0.226 | 0.077 |
| Comp. Ex. 9 | 2.0 | 0.015 | 0.333 | 0.068 |
| Ex. 4 | 1.9 | 0.034 | 0.242 | 0.121 |
| Comp. Ex. 8 | 2.8 | 0.043 | 0.443 | 0.096 |
| Ex. 6 | 1.2 | 0.000 | 0.170 | 0.080 |
| Ex. 7 | 1.2 | 0.000 | 0.147 | 0.103 |
| Ex. 5 | 1.8 | 0.000 | 0.203 | 0.174 |
| Ex. 10 | 1.8 | 0.098 | 0.128 | 0.151 |
| Ex. 12 | 0.9 | 0.022 | 0.094 | 0.078 |

TABLE 4
Activation factors after 15 min and results from catalytic testing of the prepared catalysts.

| | | | ¹⁷O-NMR: | | | |
|---|---|---|---|---|---|---|
| | activation | | mmol μ- | | | PO activity/ |
| | factor | water | peroxo/ | | | H₂O₂ |
| | (15 min) | adsorption | mol Ti (15 min) | PO test | K-80 | decomposition |
| # | [mmol/mol] | [g/g] | [mmol/mol] | [wt.-%] | test [h⁻¹] | rate |
| Comp. Ex. 8 | 77 | 0.117 | 657 | 7.4 | 0.936 | 7.9 |
| Comp. Ex. 9 | 76 | 0.115 | 660 | 8.7 | 0.56 | 15.5 |
| Ex. 3 | 52 | 0.096 | 537 | 8.2 | 0.41 | 20.0 |
| Ex. 2 | 45 | 0.0845 | 536 | 7.7 | 0.36 | 21.4 |
| Ex. 5 | 46 | 0.070 | 655 | 9.3 | 0.23 | 40.4 |
| Ex. 6 | 26 | 0.034 | 765 | 10.4* | 0.179 | 58.1 |
| Ex. 4 | 30 | 0.0725 | 412 | 9.4 | 0.16 | 58.8 |
| Ex. 1 | 29 | 0.075 | 386 | 3.7 | 0.12 | 30.8 |
| Ex. 7 | 29 | 0.044 | 663 | 12.1 | 0.55 | 22.0 |
| Ex. 10 | 22 | 0.063 | 351 | 11.7 | 0.07 | 167.1 |
| Ex. 12 | 24 | 0.053 | 453 | 5.9** | 0.09 | 84.3 |

*PO test conducted in accordance with Reference Example 1.6 yet employing only 0.25 g of catalyst instead of 0.5 g.
**PO test conducted based on the procedure of Reference Example 1.6 for catalyst moldings.

TABLE 5
Activation factors after 2 h and results from catalytic testing of the prepared catalysts.

| | | | ¹⁷O-NMR: | | | |
|---|---|---|---|---|---|---|
| | activation | | mmol μ- | | | PO activity/ |
| | factor | water | peroxo/ | | | H₂O₂ |
| | (2 h) | adsorption | mol Ti (2 h) | PO test | K-80 | decomposition |
| # | [mmol/mol] | [g/g] | [mmol/mol] | [wt.-%] | test [h⁻¹] | rate |
| Comp. Ex. 8 | 89 | 0.117 | 757 | 7.4 | 0.936 | 7.9 |
| Comp. Ex. 9 | 91 | 0.115 | 795 | 8.7 | 0.56 | 15.5 |
| Ex. 3 | 69 | 0.096 | 719 | 8.2 | 0.41 | 20.0 |
| Ex. 2 | 49 | 0.0845 | 584 | 7.7 | 0.36 | 21.4 |
| Ex. 5 | 38 | 0.070 | 540 | 9.3 | 0.23 | 40.4 |
| Ex. 6 | 23 | 0.034 | 677 | 10.4* | 0.179 | 58.1 |
| Ex. 4 | 44 | 0.0725 | 609 | 9.4 | 0.16 | 58.8 |
| Ex. 1 | 32 | 0.075 | 431 | 3.7 | 0.12 | 30.8 |
| Ex. 7 | 26 | 0.044 | 584 | 12.1 | 0.55 | 22.0 |
| Ex. 10 | 21 | 0.063 | 341 | 11.7 | 0.07 | 167.1 |
| Ex. 12 | 26 | 0.053 | 492 | 5.9** | 0.09 | 84.3 |

*, **see Table 4.

As it can be gathered from the results shown in tables 4 and 5, it has quite surprisingly been found that the catalysts of the examples in accordance with the present invention, thus having an activation factor in the range of from 10 to 75 after 15 min as well as after 2 h, show far lower decomposition rates of H₂O₂ as determined according to the K-80 test than the catalysts according to the comparative examples. In particular, the catalysts according to Comparative Examples 8 and 9 show decomposition rates of H₂O₂ of 0.936 and 0.56, respectively. In contrast thereto, the catalysts of the present invention show at most a decomposition rate of H₂O₂ of 0.41 for the catalyst according to Example 3. The lowest decomposition rate of H₂O₂ is shown by the catalyst according to Example 1 where said rate was 0.12.

In addition, the catalysts according to the present invention show at least a good if not an excellent performance in the PO test, as can be seen from the results shown in tables 4 and 5. In particular, the catalysts according to Examples 4-7 show a better performance in the PO test than the catalysts according to Comparative Examples 8 and 9. In particular, it has quite surprisingly been found that the catalyst according to Example 6 displays an extremely good performance, since it displays the second highest activity in the test although only half of the amount of the catalyst was employed compared to the other samples which were tested.

For better comparison, the results from the K-80 and PO tests have been compiled by calculating the quotient of the PO activity to the H₂O₂ decomposition rate obtained from the K-80 test for each of the tested samples. Thus, as may be taken from the last column in Tables 4 and 5, said quotient is greater for each and every of the inventive examples compared to Comparative Examples 8 and 9.

### BRIEF DESCRIPTION OF THE FIGURES

FIG. 1: shows a μ²η²-peroxo species bridging two Ti atoms.

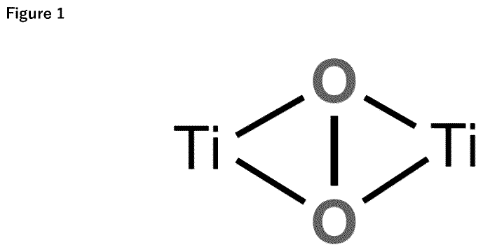

### CITED LITERATURE

U.S. Pat. No. 4,410,501
WO 2020/074586 A1
C. P. Gordon et al., Nature 2020, 586, 708-713
WO 2011/064191 A1
D. Massiot et al., Magnetic Resonance in Chemistry 2002, vol. 40, p. 70-76
R. Bai et al., Chemical Science 2022, vol. 13, p. 10868-10877
I. C. Madsen and N. V. Y. Scarlett, Chapter 11.3.2.1, in Powder Diffraction—Theory and Practice edited by R. E. Dinnebier and S. J. L. Billinge
Lamberti C., Bordiga S., Zecchina A., Carati A., Fitch A. N., Artioli G., Petrini G., Salvalaggio M., Marra G. L. “Structural Characterization of Ti-Silicalite-1: A Synchrotron Radiation X-Ray Powder Diffraction Study” in J. Catal. 1999, 183, 222-231
U.S. Pat. No. 9,302,257 B2
WO 2021/123227 A1
WO 2020/174586 A1
WO 2023/094691 A1

1.-15. (canceled)

16. A catalyst molding for hydrogen peroxide activation, wherein the catalyst molding comprises a catalyst for hydrogen peroxide activation, said catalyst comprising Ti, Si, and O, wherein the catalyst comprised in the catalyst molding displays a water adsorption (W), a concentration (C) of bridging μ²η²-peroxo species per Ti in the H₂O₂-activated catalyst as determined by quantitative ¹⁷O NMR spectroscopy, and an activation factor (A) according to formula I, wherein the activation factor is in the range of from 10 to 75 mmol/mol;
wherein in accordance with formula I, the activation factor is the multiplication product of the water adsorption and the concentration of bridging μ²η²-peroxo species per Ti in the H₂O₂-activated catalyst:
A=W×C (I).

17. The catalyst molding of claim 16, wherein the catalyst molding further comprises one or more oxidic binders.

18. The catalyst molding of claim 17, wherein the one or more oxidic binders comprise one or more sources of a metal oxide or of a metalloid oxide selected from the group consisting of silica, alumina, titania, zirconia, lanthana, magnesia, and mixtures or mixed oxides of two or more thereof.

19. The catalyst molding of claim 17, wherein the catalyst molding comprises the one or more oxidic binders, calculated as the oxide, in an amount in the range of from 1 to 90 wt.-%, based on the weight of the catalyst molding.

20. The catalyst molding of claim 17, wherein from 95 to 100 weight-% of the catalyst molding consist of the catalyst and the one or more oxidic binders.

21. The catalyst molding of claim 16, wherein the catalyst molding exhibits a water adsorption in the range of from 1 to 15 wt.-%.

22. The catalyst molding of claim 16, wherein the catalyst molding exhibits a BET specific surface area in the range of from 50 to 700 m²/g.

23. The catalyst molding of claim 16, wherein the catalyst molding exhibits a total pore volume in the range of from 0.2 to 1.5 g/ml.

24. The catalyst molding of claim 16, wherein the catalyst molding exhibits an average crush strength in the range of from 3 to 30 N.

25. The catalyst molding of claim 17, wherein from 95 to 100 weight-% of the one or more oxidic binders comprised in the molding consist of Si and O.

26. The catalyst molding of claim 16, wherein the catalyst molding has a sodium content, calculated as Na₂O, in the range of from 0 to 0.5 weight-% based on the weight of the catalyst molding.

27. The catalyst molding of claim 16, wherein the catalyst molding exhibits an acid site density in the range of from 1 to 1000 μmol/g at a temperature below 250 °C, determined according to Reference Example 1.9.

28. The catalyst molding of claim 16, wherein the catalyst molding is in the form of a strand.

29. The catalyst molding of claim 16, wherein the catalyst molding is an extrudate.

30. A catalyst or catalyst component in a reaction involving one or more of C—O bond formation, C—C bond formation and C—C bond conversion comprising the catalyst molding according to claim 16.
